(19) United States
(12) Patent Application Publication
(10) Pub. No.: US 2024/0042941 A1
(43) Pub. Date: Feb. 8, 2024

(54) VEHICLE MOUNTED SERVICE UNIT

(71) Applicant: HITCH & GO PTY LTD., Molendinar (AU)

(72) Inventor: Adrian RASO, Molendinar (AU)

(21) Appl. No.: 18/454,979

(22) Filed: Aug. 24, 2023

Related U.S. Application Data
(63) Continuation-in-part of application No. PCT/AU2022/050152, filed on Feb. 24, 2022.

(30) Foreign Application Priority Data
Feb. 24, 2021 (AU) 2021900504
Aug. 25, 2021 (AU) 2021221717

(51) Int. Cl. B60R 9/06; A47J 37/07; E04H 15/06

(52) U.S. Cl. CPC B60R 9/06; A47J 37/07; E04H 15/06; B60R 2011/0084

(57) ABSTRACT

A vehicle mounted camping unit having a unit housing for providing amenities for use in camping activities. A vehicle mounting arrangement extends from the unit housing. The mounting arrangement has a tow hitch that is configured for operatively coupling the camping unit to a vehicle. The camping unit has first and second retractable support legs mounted on the unit housing that are configured to support the unit housing on a support surface. The first and second retractable support legs are laterally spaced from each other on the unit housing and defining a transverse leg axis therebetween. The camping unit further includes a jockey wheel on the vehicle mounting arrangement that is configured to support the camping unit on the support surface.

### FIELD

This invention relates broadly to a vehicle mounted service unit. It also extends to a vehicle including the vehicle mounted service unit.

This invention relates, particularly but not exclusively, to a vehicle mounted service unit that is a camping unit which is suitable for camping activities and that can be mounted directly on a vehicle and does not contact with the ground during travel of the vehicle. It will therefore be convenient to hereinafter describe this invention with reference to this example application. However, at the same time, it should be clearly understood that it is capable of broader application.

### Definitions

In this specification, the use of the terms ‘suitable’ and ‘suitably’ and similar terms, is not to be read as implying that a feature or step is essential, although such features or steps referred to as ‘suitable’ may well be preferred.

In this specification, the indefinite articles ‘a’ and ‘an’ are not to be read as singular indefinite articles or as otherwise excluding more than one or more than a single subject to which the indefinite article refers. For example, ‘a’ support includes one support, one or more supports, and a plurality of supports.

In this specification, the term ‘comprising’ is intended to denote the inclusion of a stated integer or integers, but not necessarily the exclusion of any other integer, depending on the context in which that term is used. This applies also to variants of that term such as ‘comprise’ or ‘comprises’.

In this specification, the terms ‘consisting essentially of’ and ‘consists essentially of’ are intended to mean a non-exclusive inclusion only to the extent that, if additional elements are included beyond those elements recited, the additional elements do not materially alter basic and novel characteristics. That is, an apparatus, system, or method that ‘consists essentially of’ one or more recited elements includes those elements only, or those elements and any additional elements that do not materially alter the basic and novel characteristics of the apparatus, system, or method.

In this specification, terms such as ‘above’ and ‘below’, ‘front’ and ‘back’, ‘top’ and ‘bottom’, ‘left’ and ‘right’, ‘horizontal’ and ‘vertical’, and the like, may be used for descriptive purposes. However, it will be understood that embodiments can potentially be arranged in various orientations, and that such relative terms are not limiting and may be interchangeable in appropriate circumstances.

In this specification, unless the context requires otherwise, the terms ‘connection’, ‘connected’, ‘connecting’, and the like, are not to be read as limited to direct connections and may also include indirect connections. For example, unless the context requires otherwise, a stated first component ‘connected’ to a stated second component may be connected via, through or by one or more unstated components.

### BACKGROUND

Camping, four-wheel driving, and beach visits are common recreational activities in many parts of the world. When engaging in these and similar activities, camper trailers or caravans may be used to transport and provide the equipment and amenities that are required to enable people to eat and sleep at a camping location. However, with a camper trailer, particularly for shorter outings, it can be challenging to balance convenience for packing and transport with ready access to equipment.

A camper trailer comprises a separate and independent vehicle with wheels that travel along the ground that is towed by a towing vehicle in use. A camper trailer therefore needs to be licensed, and to be roadworthy for it to be taken onto public roads. There is therefore some cost and effort involved with compliance in owning and running a camper trailer.

There are some other shortcomings with camper trailers. For example, a camper trailer occupies a similar floor surface area to a car and needs a comparable amount of space for it to be stored. This can be difficult in modern residential environments where land area is at a premium and many land block sizes are small.

Another limitation of a camper trailer is the cost of these vehicles. Because they are fully fledged vehicles (in their own right), the costs of building or acquiring a camper trailer are substantial. Applicant understands that the costs of a basic camper trailer can easily exceed A$100,000. This is a very substantial outlay for some families, and they cannot easily afford a camper trailer.

Further, some accessories relating to cargo storage and some camping accessories for mounting to vehicles have previously been developed. Applicant is aware of some camping accessories that can be directly mounted on a vehicle. For example, Applicant is aware of one publicly known prior arrangement where a barbeque is mountable on a rear of a vehicle. This then provides a barbeque cooking facility mounted on the vehicle available for use when the vehicle is taken on a trip.

Some limitations of existing camping accessories that are mountable on a vehicle include the following: insufficient sturdiness or simplicity of design; excessive size or weight for transport or storage; limited inclusion of or storage space for equipment or implements; requirements for attachment or detachment that are difficult or impossible for a single person; inconvenient mounting arrangements, such as arrangements using internal vehicle space; lack of durability; and/or difficulties for cleaning or maintenance.

The reference to prior art in the background above is not and should not be taken as an acknowledgment or any form of suggestion that the referenced prior art forms part of the common general knowledge in Australia or in any other country.

### SUMMARY OF INVENTION

Applicant recognizes the limitations of existing camper trailers that are separate vehicles in their own right and are hitched up to a vehicle and towed by the vehicle on a camping trip.

Applicant recognizes that it would be beneficial if a more compact camping unit could be devised that was mounted on a vehicle and was carried around by the vehicle on a camping trip.

Applicant also recognizes that the functionality and amenity provided by currently known vehicle mounted camping accessories is very limited and does not remotely approximate the amenity offered by a camper trailer.

According to one aspect of the invention there is provided a vehicle mounted camping unit comprising:
a unit housing for camping amenities used in camping activities;
a vehicle or camping unit mounting arrangement on which the unit housing is supported for operatively mounting the unit housing on a vehicle; and
a plurality of retractable support legs mounted on the unit housing that are extendible down to a support surface beneath the unit housing, wherein the support legs are suitable for supporting the camping unit on a support surface when it is mounted on the vehicle, and suitable for independently supporting the camping unit and displacing it across a support surface when it is detached from the vehicle.

The camping unit may be interchangeable between a travelling configuration where it is mounted up on the vehicle suitable for driving on a road and a camping configuration suitable for providing camping amenities at a camp site.

The legs may support the housing in a desired orientation, e.g. in a horizontally extending orientation, when the camping unit is in the camping configuration and either connected to the vehicle or detached from the vehicle. The legs may also enable the camping unit to be independently supported above the support surface when it is demounted (detached) from the camping vehicle and is in the process of being moved around.

Each support leg may be independently extended or shortened whereby to adjust a height of the unit housing, for example, to provide a level housing on a support surface.

Each support leg may comprise two leg sections that are axially displaceable relative to each other, and a linear actuator for selectively driving displacement of the two leg sections relative to each other to extend or shorten the leg.

Further, each leg has an upper end mounted to the unit housing and a lower end for bearing against a support surface. The leg may include a wheel mounted on the lower end thereof for rolling across a support surface, e.g. a swivel wheel. The leg may also include a mounting plate mounted on the lower end thereof.

The vehicle mounted camping unit may include a surface orienting arrangement for orienting a surface of the camping unit in a certain or desired orientation.

The surface orienting arrangement may be used for levelling a surface of the camping unit, e.g. a horizontally extending surface of the camping unit on a support surface.

The surface orienting arrangement may comprise a sensor for sensing an inclination of the housing and providing sensing information, and a controller that is operatively connected to the sensor for receiving the sensing information from the sensor.

The controller may be operatively coupled to the support legs to independently adjust the length of each leg in response the sensing information to orient the surface in the certain or desired orientation.

Thus, the controller may control operation of the linear actuator on each support leg to extend or shorten the leg using the linear actuator on the leg in response to the sensing information received from the sensor.

The sensor may be an accelerometer that is used to sense orientation of the surface.

The controller may also be used to adjust the height of the housing above the support surface through the independently controlled support legs. The controller may have a plurality of pre-set heights which can be selected by a user. The controller may also permit a user to adjust the height of the housing to a desired height.

The camping unit mounting arrangement may include a hitch for coupling up to a hitch receiver on the camping vehicle, a housing mount on which the camping unit housing is mounted, and a mounting displacement mechanism that is intermediate the hitch and the housing mount, for displacing the housing mount away from the hitch.

The hitch may comprise a male member for insertion into a female hitch receiver to operatively couple the camping unit to the camping vehicle.

The hitch may further include a hitch lock for locking the hitch to the hitch receiver, whereby to lock the camping unit in its position mounted to the camping vehicle.

The hitch lock may comprise at least one friction gripping arrangement on the male member that can be displaced outward into frictional locking with a wall of the female hitch receiver on the camping vehicle. Conveniently, the friction gripping arrangement's may be displaced outward by a ratcheting mechanism which permits only an outward displacement.

The mounting displacement mechanism intermediate the hitch and the housing mount may displace the housing mount between a travelling configuration in which the housing mount is proximate to the hitch, and an extended camping configuration in which the housing mount is spaced away from the hitch, and a rear of the camping vehicle on which the camping unit is mounted.

The mounting displacement mechanism intermediate the hitch and the housing mount may comprise a slide mechanism including a plurality of telescoping or slide members that can slide axially relative to each other while still supporting the housing on the housing mount. The plurality of slide members may be configured to support each other and to limit movement of the axial members relative to each other to an axial direction.

The slide mechanism may further include linear actuators engaging one of the slide members and driving displacement of the slide mechanism to move the housing mount between the travelling and camping configurations. One end of the actuator may be mounted on the hitch or mounting displacement mechanism and the other end on the housing or the housing mount.

Instead, the mounting displacement mechanism may comprise a folding parallelogram linkage in which the linkage members can be folded between a collapsed configuration and an expanded configuration. The folding parallelogram linkage may further include at least one linear actuator driving the linkage members between the collapsed and expanded configurations to move the housing mount between the travelling and camping configurations.

Yet further instead, the mounting displacement mechanism may comprise a pair of folding arms that are arranged in series, e.g. end to end, that can be pivoted between a folded travelling configuration and an outward extending camping configuration. This enables the camping unit to be pivoted, e.g. manually pivoted by a user, away from a rear of the vehicle on which it is mounted with two degrees of freedom.

The camping unit mounting arrangement may further include a tilting arrangement permitting the housing mount (and the housing on the housing mount) to tilt relative to the hitch and/or the mechanical displacement mechanism.

The tilting arrangement may comprise a spherical bearing, a top plate mounted on the spherical bearing, and a pair of opposed springs extending from the mounting displacement mechanism to the top plate. The springs may be under tension and pull on the top plate from either side.

The tilting mechanism enables the unit housing to tilt relative to the hitch to enable the unit housing to be levelled while still being mounted on the vehicle. It enables the camping unit to be levelled on a support surface when operatively connected to the camping vehicle regardless of whether it is parked on uneven ground.

The unit housing may include a working counter surface for preparing and serving food and cleaning up food.

The unit housing may further include a wash basin in proximity to the working counter surface, e.g. alongside the working counter surface.

The unit housing may further include a cook plate in proximity to the working counter surface, e.g. alongside the working counter surface and/or the wash basin. Conveniently, the working counter surface, wash basin and hot plate may all be arranged in a line at approximately the same height.

The camping unit may further include a water tank mounted on the unit housing for supplying water to the wash basin.

Thus, the unit housing may include at least one storage drawer, e.g. a plurality of drawers, received within the unit housing that can be pulled out of the housing to access items, e.g. food or cutlery, stored in the drawer/s.

The vehicle mounted camping unit may further include a shade structure mounted on the unit housing interchangeable between a stowed configuration in which it is retracted and a deployed configuration in which it extends over a support surface, e.g. an area of a support surface, adjacent to the camping unit and provides shade.

The shade structure may include a shade support extending up from the housing and a flexible shade sail extending from the support that provides the shade. The shade support may be pivotable between a stowed configuration and an upstanding operative configuration.

The shade structure may further include two or more support posts mounted on the ground and supporting the shade sail at points spaced from the unit housing. These support posts may resemble tent poles that are inserted into the ground and extend up to their upper ends which support the shade sail.

The camping unit may further include a refrigerator mounted on the unit housing. The refrigerator may be a camping refrigerator that is powered by electricity and is received within a refrigeration zone, e.g. a refrigeration compartment within the unit housing.

The vehicle mounted camping unit may further include a barbeque mounted on the unit housing and interchangeable between a stowed configuration in which it is received within the unit housing and an extended operative configuration in which it projects from the housing and can be used for cooking. In one example form, the barbeque projects laterally out of a side of the housing.

The vehicle mounted camping unit may further include a battery, e.g. a lithium-ion battery, mounted on the unit housing for providing electrical power to the camping unit, and, in particular the various electrical fittings and appliances on the camping unit.

The camping unit may further include a power management system on the unit housing for managing the supply of power from the battery to various appliances and electrical fittings on the camping unit. The camping unit may further include an electrical power connector for coupling the camping unit to an external power supply for charging the battery for energising the appliances and fittings on the camping unit.

The vehicle mounted camping unit may comprise inner and outer housing sections that are telescopically displaceable relative to each other between a compact travelling configuration and an expanded camping configuration wherein the outer housing section defines an internal space in the expanded camping configuration forming a covered space that can be used for camping activities.

In particular, the outer section may form a roof and at least two side walls defining the internal space, and the internal space can be used to form a sleeping zone for campers to sleep in. In one example form, the outer section has three side walls, and the adjacent inner section forms a fourth wall.

According to another aspect of the invention there is provided a vehicle mounted camping unit, comprising:
a camping unit mounting arrangement for operatively mounting the camping unit onto a camping vehicle;
a unit housing mounted on the camping unit mounting arrangement, the unit housing forming a working counter surface, and/or a cook plate and/or a wash basin mounted on the unit housing in proximity to the working counter surface; and
a shade structure mounted on the unit housing and interchangeable between a stowed configuration in which it is retracted, and a deployed configuration in which it extends over a support surface area adjacent to the camping unit for providing shade.

The shade structure may include a shade support that is pivotable up from the unit housing and a flexible shade sail extending from the shade support that provides the shade.

The shade structure may further include two or more support posts mounted on the support surface and supporting the shade sail at points spaced from the unit housing.

The unit housing may comprise inner and outer housing sections that are telescopically displaceable relative to each other between a nested travelling configuration and an expanded camping configuration where the two sections are expanded relative to each other, and the outer section defines an internal space that can be used for camping activities by the users of the camping unit.

In particular, the outer section may form a roof and at least two side walls, and can be used to form a sleeping zone for campers to sleep in. In one example form, the outer section has three side walls, and the adjacent inner section forms a fourth wall.

The unit housing may further include a water tank mounted on the housing supplying water to the wash basin and the cook plate and the wash basin may be adjacent to the working counter surface.

Further, the unit housing may include at least one storage drawer, e.g. a plurality of drawers, received within the housing that can be used for storage and can be drawn out of the housing when the camping unit is in the camping configuration to access items stored in the drawers.

The camping unit may further include a housing support arrangement for supporting the camping unit on a support surface with the unit housing spaced above the support surface independently of a camping vehicle.

The housing support arrangement may comprise a plurality of retractable legs mounted on the unit housing that are independently extendible in a direction down from the housing. Each leg may have a drive arrangement for independently driving it to extend or retract as required.

The camping unit may further include a levelling arrangement for levelling the unit housing and thereby the working counter surface in the unit housing, and the levelling arrangement may be operatively connected to the plurality of legs to extend or shorten each leg to level the camping unit.

The legs may include any one or more of the features of the legs in any other aspect of the invention.

Further, the camping unit may include any one or more of the features, or combination of features, of the camping unit defined in any other aspect of the invention.

According to another aspect of the invention there is provided a vehicle mounted camping unit for mounting on a camping vehicle, the camping unit comprising:
a unit housing; and
a camping unit mounting arrangement for operatively mounting the unit housing onto a camping vehicle, the unit mounting arrangement comprises a hitch for coupling to a hitch receiver on the camping vehicle, and a housing mount on which the camping unit housing is mounted, and a mounting displacement mechanism intermediate the hitch and the housing mount for displacing the housing mount between a travelling configuration up against a rear of the camping vehicle and a camping configuration displaced away from the rear of the camping vehicle, whereby to enable the camping unit to be displaced away from the rear of the camping vehicle to provide access to a rear door of the camping vehicle in the camping configuration.

The mounting displacement mechanism enables the camping unit to be displaced or moved away from a rear of the vehicle when it is in the camping configuration. This enables a rear door or hatch of the vehicle to be accessed in the camping configuration recognising that it is difficult to access the rear door when the camping unit is positioned up against the rear of the vehicle in the travelling configuration.

The mounting displacement mechanism may displace the housing linearly in a front to rear direction, between the travelling configuration and the camping configuration (wherein the front to rear direction is determined with reference to the front and rear of the camping vehicle).

The mounting displacement mechanism may comprise a slide mechanism including a plurality of telescoping slide members that can slide axially relative to each other between the travelling and camping configurations while still supporting the unit housing on the housing mount.

In one form, the slide mechanism may comprise a pair of slidably engaged slide members that are displaceable in an axial direction between the travelling and camping configurations. The slide members are configured to support each other and can only move in an axial direction relative to each other. The mechanism further includes a linear actuator engaging at least one of the slide members and driving displacement of the slide mechanism between the travelling and camping configurations.

In another form, the mechanism comprises a folding parallelogram in which the linkages can be displaced between a collapsed configuration and an expanded configuration to drive the housing mount between the travelling and camping configurations.

In yet another form, the mounting displacement mechanism comprises a pair of folding arms that are arranged in series, e.g. end to end, and are pivoted away from the hitch between the travelling configuration in which the arms are folded against the rear of the camping vehicle, and the outward extending camping configuration in which the arms are pivoted outward away from the rear of the vehicle.

The camping unit mounting arrangement may include any one or more of the features, or combination of features, of the unit mounting arrangement in any other aspect of the invention.

Further, the camping unit and unit housing may include any one or more of the features, or combination of features, of the camping unit and unit housing in any other aspect of the invention.

According to another aspect of the invention there is provided a vehicle mounted service unit comprising:
a unit housing defining a unit space for utilisation in the operation of the service unit;
a unit mounting arrangement on which the unit housing is supported, and which operatively mounts the housing on a carrying vehicle in use; and
a plurality of retractable support legs mounted on the unit housing that are extendible down to a support surface beneath the unit housing, wherein the support legs are suitable for supporting the service unit on a support surface when it is mounted on the carrying vehicle, and are also suitable for independently supporting the service unit and displacing it across a support surface when it is detached from the carrying vehicle.

The unit space defined by the unit housing may be utilized in a wide variety of ways in the operation of the service unit.

In some forms, the unit space for utilization in the operation of the service unit may form an interior unit space. In other forms, the unit space for utilization in the operation of the service unit may form an open space that is not enclosed.

In one form, the service unit may be a mobile kitchen unit which can be used to provide kitchen facilities at various locations. The mobile kitchen unit can be transported on the carrying vehicle to any location, and then be demounted or detached from the carrying vehicle and set up as a temporary kitchen unit.

In another form, the service unit may be a cargo carrier which can be used to carry a cargo from one location to another. The term ‘cargo’ is to be broadly interpreted and covers all types and manner of carried goods. The cargo carrier can be transported by the carrying vehicle to a location and then be demounted or detached from the carrying vehicle together with its carried cargo. The service unit is then able to be moved around to where it is required without removing the cargo. The cargo only need be removed from the unit housing at an end point, and this reduces handling of the cargo.

In another variation, the service unit may be a mobile refrigeration unit. The mobile refrigeration unit may be used to transport and deliver refrigerated goods to different locations. It can then provide refrigerated goods at these locations by demounting the unit and standing it on a support surface without requiring any handling of the refrigerated items. It could also be used to make delivery of refrigerated goods in place of a refrigerated truck or a refrigerated trailer.

In yet another form, the service unit may be in the form of a mobile delivery unit. In this case, the unit housing may be in the form of an open topped container that can be used to hold articles, e.g. postal or courier articles, for delivery. The service unit can be transported on a vehicle and then de-mounted and the service unit can be wheeled around, and the articles delivered directly from the service unit. Applicant is aware of a great need for efficient delivery of articles with online retail services.

In another variation, the service unit may be a mechanical toolbox which can be mounted on the carrying vehicle to carry a tradesman's tools to a building site where they are required. The mechanical toolbox can be demounted from the vehicle at the work site and then wheeled around on the site. After the work is completed, it can be mounted on the vehicle once again and transported away. This service unit can be used in place of a trailer having a built-in toolbox or a dedicated utility vehicle having a built-in toolbox. In both of these instances, the toolbox cannot be separated from the trailer or utility as the case may be like the service unit which can be wheeled around a site. This confers significant working advantage on this embodiment.

In yet another form, the service unit may be a jet ski carrier which has a jet ski mounted on the unit housing. The entire service unit with jet ski mounted thereon can be transported to a ski site and then demounted from the vehicle. The service unit with ski mounted thereon can be wheeled to a point of use where the jet ski is taken off the unit housing. After use, the service unit with jet ski can be demounted and then stored away with the jet ski on the unit housing. This combination of service unit and jet ski can be stored in a compact storage location which is extremely convenient and space efficient.

In yet another form, the service unit may be a motorbike carrier which holds a motorbike on the unit housing. This way, the entire service unit with motor bike mounted thereon can be demounted from the vehicle and stored away as a combination service unit and motorbike. This may be particularly convenient for racing motorbikes and off-road motorbikes that need to be transported by a vehicle to a location where they will be used. This use of the service unit has many similarities with the preceding service unit that is a jet ski carrier.

In yet another form, the service unit may be used as a mobile retail unit where the unit housing forms a mobile retail kiosk or stall. The retail unit can be transported to a location where it is required for use and then demounted from the vehicle. The retail unit can then be wheeled into position separately from the vehicle and used as free standing and independent retail unit. After use has been completed, the unit can be mounted back up on the carrying vehicle and transported away. The retail unit can also be demounted from the carrying vehicle for storage and wheeled into its storage position easily and efficiently. Applicant has identified the following types of retail stands or kiosks: coffee stand, drinks stand including a bar, ice cream stand, or market stand. However, it will be appreciated that many other types of retail stands could also be used.

In yet another form, the service unit may be used for carrying a piece of equipment, e.g. excavating equipment, such as a portable tipper. The service unit can be used to transport the equipment, e.g. a tipper, on a carrying vehicle to a location where it is required. When the tipper is required for use, it can be demounted from the vehicle and wheeled around at the site. The equipment can then be unloaded and used on site. It will be appreciated that the service unit may obviate the need for a trailer to transport the loader with the attendant advantages.

In yet another form, the service unit may be in the form of a portable display stand having a display surface having display material thereon for visual display. The display stand can be transported around by a carrying vehicle and then demounted as and when required. Once again, this enables the display stand to be transported around for use without requiring the use of a trailer. In yet another form, the service unit may be in the form of a camping unit where the unit housing provides camping amenities like those that are provided on a camper trailer.

Each support leg on the control unit may be independently adjustable whereby to enable the support leg to be selectively extended or shortened to adjust the height of the housing. The independently adjustable support legs may also be used to adjust the orientation of the housing, e.g. to level the housing.

Each support leg may have a wheel at a lower end thereof for moving over the support surface.

Each support leg may comprise two leg sections that are axially displaceable relative to each other, and a linear actuator for selectively driving displacement of the leg sections relative to each other to extend or shorten the leg.

The vehicle mounted service unit may include a surface orienting arrangement for orienting a surface of the service unit in a certain or desired orientation.

The surface orienting arrangement may be used for levelling a surface of the camping unit, e.g. a horizontally extending surface of the service unit on a support surface.

The unit housing may have an operatively top surface and a bottom surface, and the sensor may be mounted on a bottom wall of the unit housing.

The surface orienting arrangement may comprise a sensor for sensing an inclination of the housing and providing sensing information, and a controller that is operatively connected to the sensor for receiving the sensing information from the sensor.

The controller may be operatively coupled to the support legs whereby to adjust the length of the legs to orient the surface of the service unit and independently adjust the length of each leg in response the sensing information to orient the surface in the certain or desired orientation.

Thus, the controller may control operation of the linear actuator on each support leg, to extend or shorten the leg using the linear actuator on the leg in response to the sensing information received from the sensor.

The sensor may be an accelerometer that is used to sense orientation of the surface.

The controller may also be used to adjust the height of the housing above the support surface through the independently controlled support legs. The controller may have a plurality of pre-set heights which can be selected by a user. The controller may also permit a user to adjust the height of the housing to a desired height.

The service unit mounting arrangement may include a hitch for coupling to a hitch receiver on the carrying vehicle, and a housing mount on which the unit housing is mounted, and a mounting displacement mechanism in between the hitch and the housing mount, for displacing the housing mount away from the hitch.

The hitch may comprise a male member for insertion into a female hitch receiver on the carrying vehicle.

The hitch may further include a hitch lock for locking the hitch to the hitch receiver, whereby to operatively couple the service unit to the carrying vehicle.

The hitch lock may comprise an arrangement of at least one friction gripping element on the male member that can be ratcheted outward into frictional locking with an inner surface of the female hitch receiver on the carrying vehicle.

The mounting displacement mechanism may displace the housing mount between a travelling configuration in which the housing mount is proximate to the hitch, and an extended use configuration in which the housing mount is spaced away from the hitch.

The mounting displacement mechanism may comprise a slide mechanism including a plurality of telescopic slide members that are configured to slide axially relative to each other.

The mounting displacement mechanism may comprise a pair of folding arms that are arranged in series that can be pivoted between a folded configuration and an outward extending configuration.

The service unit mounting arrangement may further include a tilting arrangement on which the unit housing is mounted which permits the housing mount to tilt relative to the mounting displacement mechanism and/or hitch whereby to enable the unit housing to be levelled when the carrying vehicle is on an inclined support surface.

The service unit may further include a battery mounted on the housing for providing electrical power to the service unit, and an electrical power connector for coupling the service unit to an external power supply for charging the battery.

The service unit may comprise two housing sections that are telescopically displaceable relative to each other between a compact travelling configuration and an expanded use configuration, and one housing section defines an internal void in the expanded use configuration forming a covered space that can be used.

Further, the vehicle mounted service unit may include any one or more of the features, or combination of features, of a service unit or camping unit in any other aspect of the invention in the summary of invention.

According to another aspect of the invention there is provided a vehicle mounted camping unit comprising:
a unit housing for providing amenities for camping activities;
a vehicle mounting arrangement on which the unit housing is supported, the vehicle mounting arrangement comprising a tow hitch that is configured for operatively coupling the camping unit to a tow vehicle; and
first and second retractable support legs mounted on the unit housing that are configured for supporting the unit housing on a support surface, the first and second retractable support legs being laterally spaced from each other on the unit housing and defining a transverse leg axis therebetween; and
a jockey wheel mounted on the vehicle mounting arrangement that is configured for supporting the vehicle mounting arrangement on the support surface,
wherein the first and second retractable support legs and the jockey wheel are operable to support the camping unit on the support surface when it is uncoupled from the tow vehicle.

The first and second retractable support legs, and optionally also the jockey wheel, can also be used to support the camping unit on the support surface when the camping unit is operatively coupled to the tow vehicle.

Each of the first and second retractable support legs may be able to be independently extended or shortened to adjust a height of the unit housing.

Further, each said retractable support leg may have a wheel at a lower end thereof for running on the support surface.

The unit mounting arrangement may comprise an axial tow axis extending from the tow hitch to the unit housing, and the jockey wheel may be positioned on or adjacent the tow axis, and the axial tow axis may be substantially orthogonal to the transverse leg axis extending between the first and second retractable support legs.

The first and second retractable support legs may be laterally aligned with each other. Further, the first and second retractable support legs may be positioned substantially equidistant from a centre line passing through the unit housing.

The jockey wheel may comprise a height adjusting arrangement, and the height adjusting arrangement may be manually operable to adjust the height of the jockey wheel by a handle.

The jockey wheel may thereby be used to adjust the height of the unit housing in a direction orthogonal to the transverse leg axis extending between the first and second retractable support legs. This provides for height adjustment in a second dimension.

Further, the jockey wheel may be substantially centrally positioned with respect to a width of the unit housing.

Typically, the height of the jockey wheel is adjusted by turning the handle on the jockey wheel. Rotation in one direction raises the height of the jockey wheel and rotation in an opposite direction lowers the height of the jockey wheel.

The vehicle mounted camping unit may further comprise a surface orienting arrangement for orienting a surface of the unit housing in a certain orientation, e.g. a specific or selected orientation, in a direction extending between the first and second retractable support legs, e.g. along the transverse leg axis extending between the first and second retractable support legs.

The surface orienting arrangement may comprise a sensor for sensing an inclination of the surface of the unit housing in the direction of the transverse leg axis (extending between the first and second retractable support legs), and a controller that is operatively connected to the sensor for receiving sensing information from the sensor, and that is also operatively coupled to the first and second retractable support legs.

The controller may be operable to independently adjust the length of each of the first and second retractable support legs in response to the sensing information, to orient the surface of the unit housing.

The vehicle mounting arrangement on which the unit housing is supported may further comprise a slide mechanism extending from the hitch, and the slide mechanism may be able to displace the unit housing between a travelling configuration in which it is adjacent to the hitch, and an extended camping configuration in which the unit housing is spaced away from the hitch.

The slide mechanism may comprise at least first and second telescoping slide members that slide axially relative to each other to displace the unit housing between the travelling and camping configurations.

The unit housing may be mounted directly on a first telescoping slide member of the slide mechanism such that it is fast therewith, and it cannot move relative to the first telescopic slide member. Optionally, the unit housing may be bolted to the first telescoping slide member.

In one form, the unit housing may be manually displaced between the travelling and camping configurations by physical exertion. For example, the unit housing may be displaced by a user pushing the unit housing away from the hitch receiver on the tow vehicle.

In another form, the vehicle mounting arrangement may further comprise a linear actuator for displacing the first and second slide members relative to each other to displace the unit housing between the travelling and camping configurations.

The hitch may be configured to pivot on the hitch receiver in a substantially horizontal direction from one side to another side, and to pivot on the hitch receiver in a substantially vertical direction up and down, thereby to enable the vehicle mounting arrangement to move in two dimensions relative to the hitch receiver to which it is operatively coupled.

This feature where the hitch is configured to move in two dimensions relative to the hitch receiver enables the unit housing to be mounted directly on the slide mechanism (without any movement of the unit housing relative to the slide mechanism). The tow hitch can accommodate some differences in orientation between a tow vehicle and the unit housing.

The terms ‘substantially horizontal direction’ and ‘substantially vertical direction’ are to be understood with reference to a hitch and a camping unit in use operatively coupled to a tow vehicle on a support surface.

This type of hitch which can pivot in two dimensions is commercially available and may be purchased off the shelf. This feature enables the camping unit being oriented at a different orientation to a tow vehicle while still being operatively coupled to the tow vehicle.

According to yet another aspect of the invention there is provided a vehicle mounted service unit for mounting on a carrying vehicle, the service unit comprising:
a unit housing; and
a service unit mounting arrangement for operatively mounting the unit housing onto a carrying vehicle, the service unit mounting arrangement comprises a hitch for coupling to a hitch receiver on the carrying vehicle, and a housing mount on which the unit housing is mounted, and a mounting displacement mechanism intermediate the hitch and the housing mount for displacing the housing mount between a travelling configuration up against a rear of the carrying vehicle and an extended use configuration displaced away from the rear of the carrying vehicle, whereby to enable the service unit to be displaced away from the rear of the carrying vehicle to access the rear.

It can be difficult to access a rear door of a carrying vehicle when the service unit is positioned up against the rear of the vehicle. The mounting displacement mechanism enables the service unit to be displaced or moved away from the rear of the vehicle to do this.

The mounting displacement mechanism may displace the housing linearly in a front to rear direction, between the travelling configuration and the extended use configuration (wherein the front to rear direction is determined with reference to the front and rear of the carrying vehicle).

The mounting displacement mechanism may comprise a slide mechanism including a plurality of telescoping slide members that can slide axially relative to each other between the travelling and extended use configurations.

Further, the vehicle mounted service unit may include any one or more of the features, or combination of features, of the service unit or camping unit in any other aspect of the invention in the summary of invention.

According to yet another aspect of the invention there is provided a vehicle in combination with a camping unit as defined in any preceding aspect of the invention.

The vehicle may have a front and a rear with reference to its direction of travel and the camping unit may be mounted on the rear of the vehicle. Further, the vehicle may be a passenger carrying vehicle having a rear door or hatch on the rear of the vehicle.

The vehicle may include a hitch receiver for mounting the camping unit on the vehicle, the hitch receiver engaging a hitch on the camping unit mounting arrangement whereby to support or carry the camping unit on the vehicle.

The hitch receiver may comprise a female member and the hitch may comprise a male member, which is received in the female member to mount the camping unit on the camping vehicle.

The female member may comprise a tube having a rearward facing open end that is sized to receive the male member of the camping unit mounting arrangement with a sliding fit.

In one form, the camping unit may be removably mounted on the vehicle. Instead, in another form, the camping unit may be permanently mounted on the vehicle. Optionally, the same hitch and hitch receiver may be used to permanently mount the camping unit on the vehicle. However, other methods of mounting the camping unit on the vehicle that would be readily understood by persons skilled in the art could also be used.

The vehicle mounted camping unit may include any one or more of the features, or combination of features, of a camping unit in any preceding aspect of the invention.

### BRIEF DESCRIPTION OF THE DRAWINGS

A vehicle mounted camping unit and a vehicle fitted with such a camping unit in accordance the invention may manifest itself in a variety of forms. It will be convenient to hereinafter describe in detail several embodiments of the invention with reference to the accompanying diagrammatic drawings. The purpose of providing this detailed description is to instruct persons having an interest in the subject matter of the invention how to carry the invention into practical effect. However, it is to be clearly understood that the specific nature of this detailed description does not supersede the generality of the preceding summary section.

FIG. 1 is a perspective view of a camping unit in accordance with a first embodiment of the invention mounted on a camping vehicle;

FIG. 2 is a rear lower perspective view of the camping unit and vehicle in FIG. 1;

FIG. 3 is a close-up perspective view showing detail of part of the camping unit in FIG. 1 showing a part of the camping unit mounting arrangement;

FIG. 4 is an upper perspective view of the vehicle and camping unit in FIG. 1 showing the camping unit in an extended camping configuration;

FIG. 5 is an upper perspective view of the camping unit of FIG. 1 shown in an expanded configuration front to rear;

FIG. 6 is an exploded perspective view of an adjustable support leg of the camping unit of FIG. 1;

FIG. 6A is a schematic drawing of the functionality of a level controller for controlling the independent legs of the camping unit;

FIG. 6B is a schematic drawing of a PCB (printed circuit board) containing an accelerometer and microcontroller for mounting on a horizontally extending surface of the unit and also a schematic flowsheet of the control system used to level the unit;

FIG. 7 is a rear view of a camping unit in accordance with a second embodiment of the invention mounted on a camping vehicle;

FIG. 8 is a side view of the camping unit and vehicle of FIG. 7;

FIG. 9 is a lower perspective view of the camping unit and vehicle of FIG. 7;

FIG. 10 is an upper perspective view of the vehicle and camping unit of FIG. 7 with the camping unit being shown in an expanded camping configuration;

FIG. 11 is a side view of the vehicle and camping unit of FIG. 7 showing its tilting arrangement;

FIG. 12 is a rear view of the vehicle and camping unit of FIG. 7 showing its tilting arrangement;

FIG. 13A is an upper perspective view of the vehicle and camping unit of FIG. 10 which camping unit has a shade structure deployed adjacent the camping unit housing to provide shade;

FIG. 13B is a lower perspective view of the vehicle and camping unit of FIG. 13A shown mounted on its support legs;

FIG. 14 is a lower perspective view of a tilt mechanism for the camping unit mounting arrangement;

FIG. 15 is an upper perspective view of a hitch lock for locking the hitch to the hitch receiver;

FIG. 16 is a lower perspective view of the hitch lock of FIG. 15;

FIG. 17 is a side perspective view of the hitch lock of FIG. 15;

FIG. 18 is another perspective view of the hitch lock of FIG. 15;

FIG. 19 is another slower perspective view of the hitch lock of FIG. 15 showing the lock urging outward for engaging the hitch receiver;

FIG. 20 is an end view of the hitch lock of FIG. 19 with the lock urging outward;

FIG. 21 is an upper perspective view of a camping unit support arrangement for a camping unit in accordance with another embodiment of the invention;

FIG. 22 is an upper perspective view of an actuator for the camping unit support arrangement in FIG. 21;

FIG. 23 is an exploded upper perspective view of a hitch for the camping unit support arrangement in FIG. 21;

FIGS. 24 to 26 are perspective views of a camping unit support arrangement in accordance with another embodiment of the invention;

FIGS. 27 to 32 are schematic drawings of the camping unit showing how the levelling arrangement and the ability to independently adjust the length of the legs assists with handling of the camping unit including mounting and demounting of the camping unit as well as levelling of the camping unit;

FIG. 33A is a lower perspective view of a service unit in accordance with another embodiment of the invention mounted to a road going vehicle in a travelling configuration and FIG. 33B is a close up of the camping unit from below;

FIG. 34 is a side view of the vehicle mounted service unit in FIG. 33A in the travelling configuration;

FIG. 35 is a rear view of the vehicle mounted service unit in FIG. 33A in the travelling configuration;

FIG. 36 is a side view of the vehicle mounted service unit in FIG. 33A in a deployed or extended camping configuration;

FIG. 37 is a rear view of the vehicle mounted service unit in FIG. 36 in a deployed or extended camping configuration;

FIG. 38 is a rear perspective view of a vehicle mounted service unit in FIG. 36 in a deployed or extended camping configuration having a canopy mounted thereto;

FIG. 39 is a schematic plan view of a vehicle mounting arrangement for mounting the camping unit to a hitch receiver on a tow vehicle (with parts omitted for clarity) in accordance with the other embodiment of the invention;

FIG. 40 is a schematic side view of the vehicle mounting arrangement in FIG. 39 used for mounting the camping unit to a hitch receiver;

FIG. 41 is a schematic rear view of the vehicle mounting arrangement in FIG. 39 used for mounting the camping unit to a hitch receiver; and

FIG. 42 is an exploded perspective view of the vehicle mounting arrangement in FIG. 39 used for mounting the camping unit to a hitch receiver on the tow vehicle.

### DETAILED DESCRIPTION

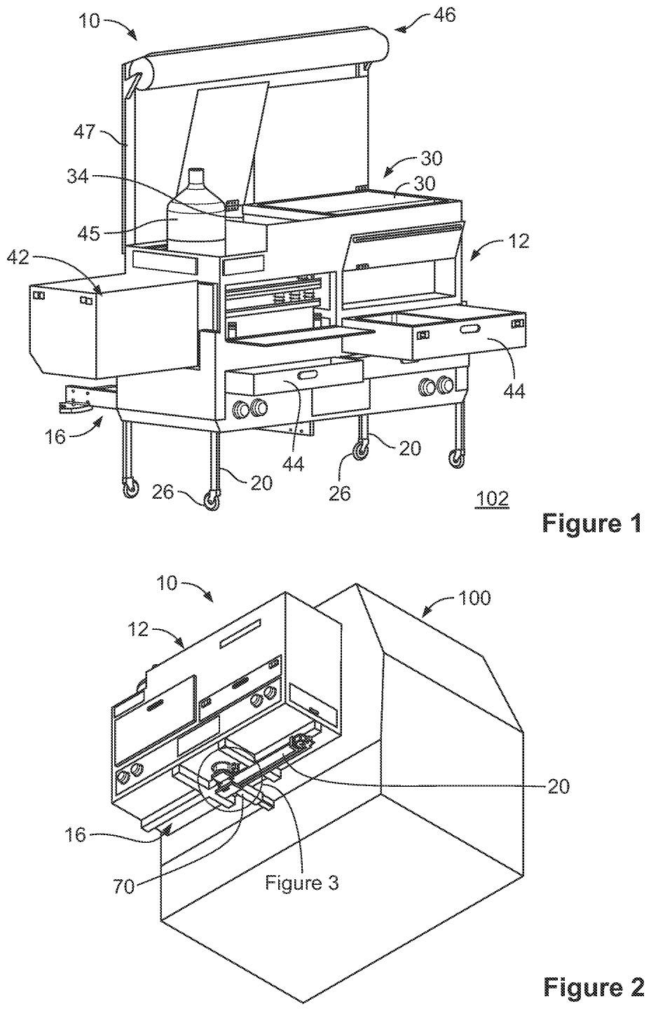

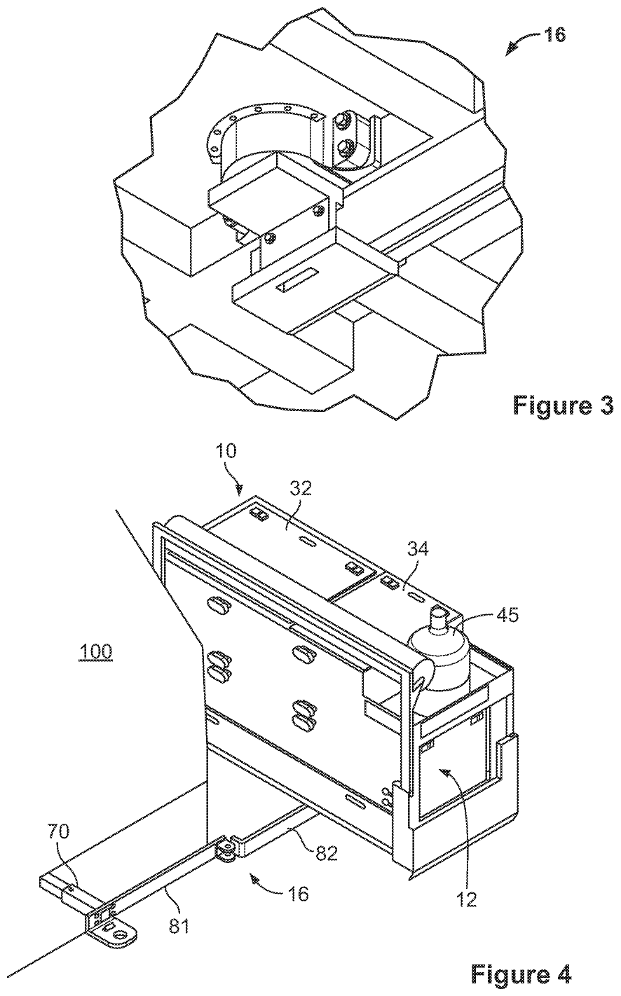

FIGS. 1 to 5 illustrate a service unit that is a camping unit in accordance with one embodiment of the invention mounted on a camping vehicle. The camping unit is indicated generally by reference numeral 10.

The camping unit 10 comprises a unit housing 12 containing or carrying a plurality of camping amenities for use in camping. The camping unit 10 also includes a vehicle mounting arrangement or camping unit mounting arrangement 16 on which the unit housing 12 is supported for mounting the housing 12 on the camping vehicle 100. Further, the camping unit 10 has a plurality of retractable legs 20 mounted on the unit housing 12 and extendible down to a support surface 102 beneath the housing 12. In the illustrated embodiment the unit 10 has four retractable legs extendible down to the support surface, e.g. to support the unit housing towards its four corners. The retractable legs 20 can be used for supporting the camping unit 10 on a support surface such as the ground 102 while it is still mounted on the vehicle 100. That is, the legs 20 provide some support for the camping unit and carry part of the load in addition to the camping vehicle which also carries part of the load. The support legs 20 are also used for supporting the camping unit 10 in an upright condition spaced above the ground 102 when the camping unit 10 is detached from the vehicle 100 at a camp site. Yet further, the legs 20 can be used to support the camping unit above a support surface when it is stowed away. Yet further, in addition to providing support for the camping unit and carrying at least some of the load, the support legs 20 can be used to adjust the height of the camping unit 10 to various heights, e.g. a convenient height for loading the camping unit up onto the vehicle 100. This thereby reduces the amount of manual lifting and manoeuvring required when a user generally handles the camping unit and moves it around, and in particular, when mounting the camping unit 10 onto a vehicle 100, e.g. for a camping or recreational trip, and demounting the unit at the end of the trip.

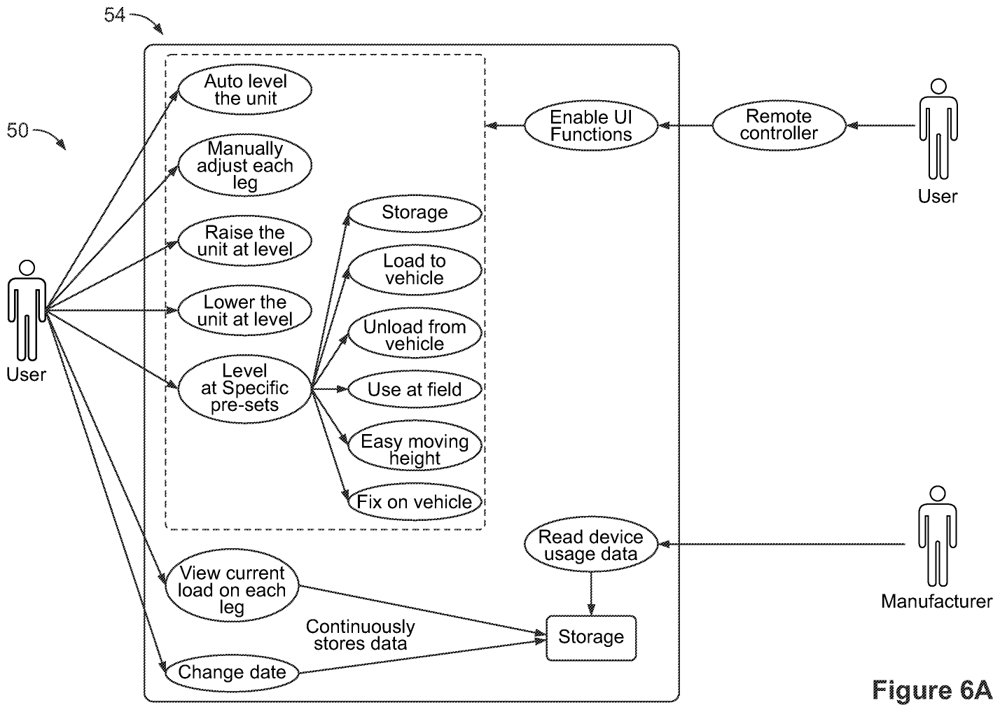

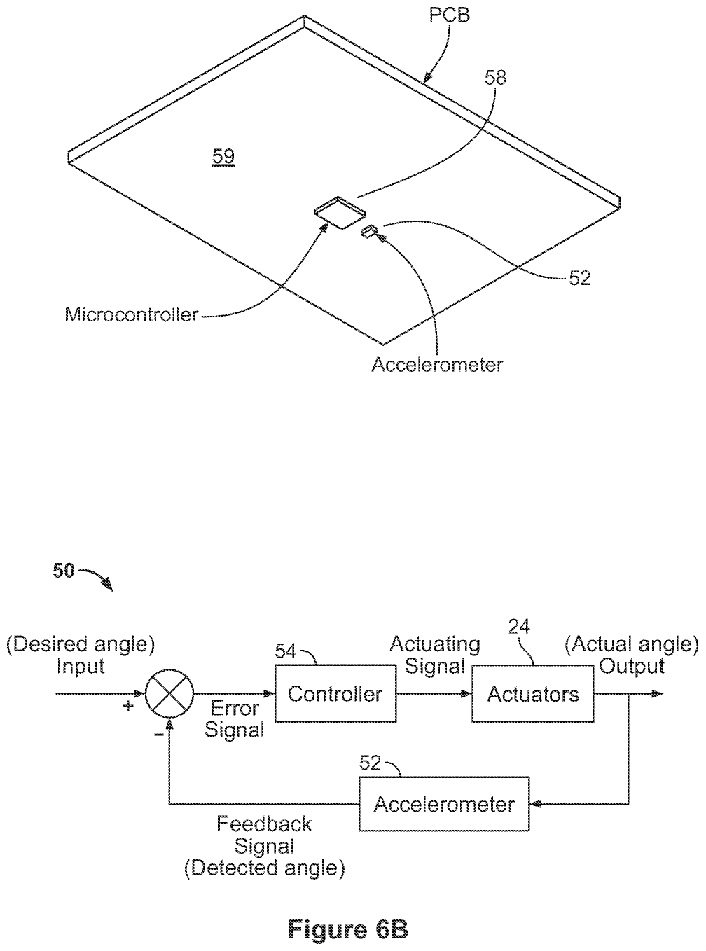

The retractable support leg is illustrated in FIG. 6 of the drawings. As shown in FIG. 6, the leg 20 has two leg sections 21 and 22 that are displaceable relative to each other to extend and shorten the leg 20. Further, each leg 20 has a linear actuator 24 that is motorized to drive lengthening or shortening of the leg 20. As the structure and function of linear actuators would be known to persons skilled in the art, they will not be described in further detail in this detailed description.

Further, as shown in FIG. 6, the support leg 20 has a wheel 26 at a lower end thereof for running over a support surface 102. Yet further, the wheel 28 at the lower end thereof can swivel on the leg 20 and thereby enable a user to steer the camping unit 10 when pushing it across a support surface 102. Additionally, the illustrated support leg 20 has a mounting plate 28 at the lower end thereof for mounting the leg 20 on a support surface 102 when a wheel 26 is neither desirable nor suitable for use, e.g. when the camping unit 10 is standing in sand.

The camping unit 10 includes a levelling arrangement indicated generally by reference numeral 50 that is operatively connected to the extendable legs 20 for levelling the unit housing on a support surface. The levelling arrangement is shown in FIGS. 6A and 6B and includes a sensor 52 for sensing an inclination of a support surface 102 on which it is mounted (thereby sensing when the housing is level). It also includes a controller 54 for receiving sensing information from the sensor 52 and, in response thereto, independently adjusting the length of the support legs 20 to support the housing 12 and surfaces thereof in a level or horizontal orientation.

Conveniently, the sensor 52 is in the form of an accelerometer that senses an inclination (or orientation or tilt angle) in a surface of the housing 12 on which it is mounted. The accelerometer 52 may be mounted on a surface, e.g. a wall of the housing 12, that is broadly horizontally extending, as distinct from being vertically extending. Conveniently, the wall of the housing may be a bottom wall 59 of the housing 12 but could also be an upper wall or a shelf on the housing 12.

The controller 54 may be a micro-controller be operatively coupled to the accelerometer 52. The accelerometer 52 and micro-controller 54 may be received in a PCB board 58 which is mounted on the horizontal bottom wall or surface 59 of the housing 12 or they may be positioned proximate to each other on the bottom surface. The controller 54 is operatively connected to each of the support legs 20, and in particular, the actuators thereof, so that it is able to direct the support legs 20 to extend or retract in response to sensing information received from the sensor 52.

Accelerometers are electromechanical devices that measure acceleration which is the rate of change of the velocity an object. They measure acceleration in metres per second squared (m/s²) or in G-forces (g). Accelerometers have been used to sense an orientation of a surface which is broadly the application of the accelerometer in the current application.

When the levelling arrangement 50 detects an inclination of the surface 59 through the accelerometer sensor 52 mentioned above, it is able to automatically adjust a length of each leg 20, e.g. through the actuators 24 thereof. The controller 54 adjusts the length of each of the support legs 20 independently, so that the camping unit 10 can be levelled irrespective of the angle of the ground surface 102 on which it is standing. This levelling arrangement 50 can operate to level the unit housing 12 without any manual input from the user.

In addition, each support leg 20 can also be extended and retracted (through the actuator 24 on each leg 20) separate from the levelling arrangement to perform other functions. The height of the surface 59 (or the height of the camping unit generally) can be adjusted automatically to a pre-set height or instead it can be manually set at a desired height. This assists with other functions such as mounting the unit on the vehicle 100, or taking the unit off the vehicle. It also assists with pushing the unit around on a support surface and lowering the unit housing to make it more compact for storage.

The functionality of an example controller 54 is illustrated in FIG. 6A of the drawings. In particular, FIG. 6A shows the following options that can be entered by a user, e.g. by means of a control pad. The user may enter an instruction to auto level the camping unit. Further, the user may input instructions to either raise the housing in a level condition or lower the housing in a level condition. Yet further, the user may enter instructions to adjust to the housing to a preset level, e.g. a height or level for loading or unloading the camping unit or a height or level for storing the unit 10 in a compact space.

The housing 12 comprises a rectangular box-like structure as shown in the drawings. The housing 12 has a front face and a rear face respectively, and two sides and extending between the front and rear faces.

The unit housing 12 is divided up into several zones and compartments, each of which has a specific purpose as will be described below. The different zones in the unit housing 12 and the camping amenities provided in these zones on the unit housing 12 will be described in more detail below with reference to the drawings. In general, the zones, compartments and openable panels are configured to allow access to, and use of various implements of the unit housing 12, as hereinabove described, and to allow for storage of other equipment or utensils such as cutlery and crockery. Compartments and openable panels can also be configured to form surfaces for activities such as preparation of food and drinks.

Turning now more specifically to FIGS. 1 to 5, the housing 12 includes an upwardly facing counter surface or working surface 30 which can be used for preparing food and arranging food. The housing 12 also includes an upwardly facing cook top 32 that is arranged on the unit housing 12 adjacent to the working counter 30. The cook top 32 may be a gas cook top, or it may be an electric cook top. The unit housing 12 also includes an upwardly facing wash basin 34 that is poisoned adjacent the working counter 30 and the cook plate 32.

The unit housing 12 further forms and defines a refrigerator cavity housing a camping refrigerator (not shown). The camping unit 10 further includes a barbeque 42 mounted on a shelf of the housing 12 and interchangeable between a stowed configuration in which it is received within the unit housing 12 and an extended operative configuration in which it projects from the unit housing 12 and can be used. In one example form, the barbeque 42 projects laterally out of one side of the unit housing 12 in its operative configuration.

The unit housing 12 also includes a plurality of storage drawers 44 received within the unit housing 12 that can be used to store camping equipment. The drawers 44 can be slid out of the unit housing 12 to access items stored in the drawers 44.

The camping unit 10 further includes a water tank 48 mounted on the housing 12 for providing a water supply for use during camping. In the illustrated embodiment, the water tank 48 is mounted on a shelf and projects up through an open top of the housing 12.

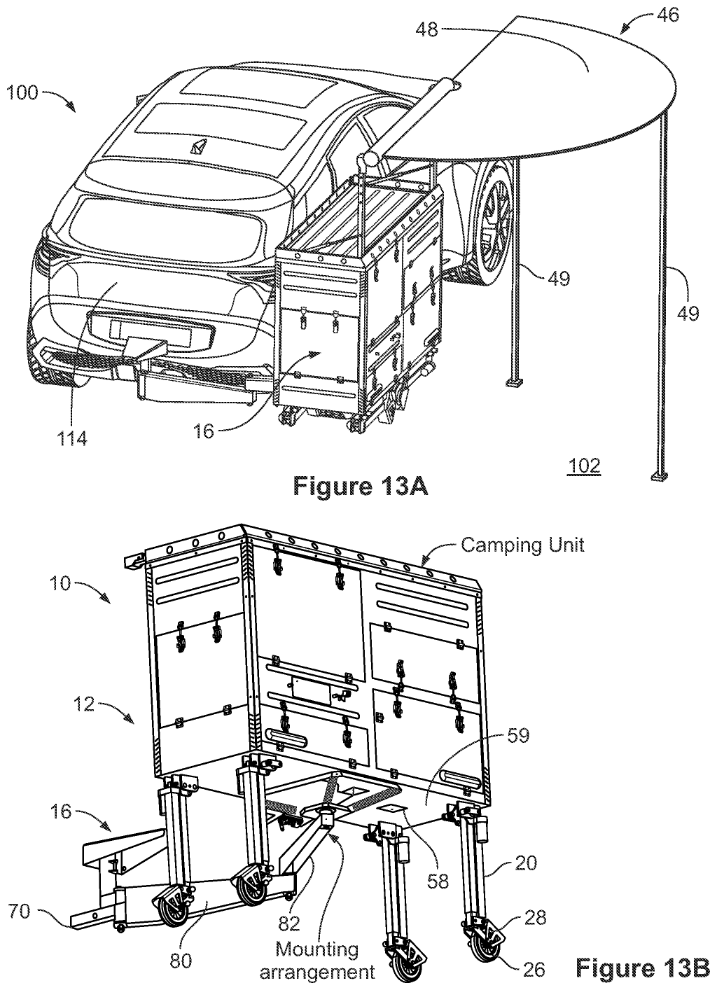

The camping unit 10 further includes a shade structure 46 mounted on the housing 12 and interchangeable between a stowed configuration in which it is retracted, and a deployed configuration in which it extends over a support surface 102 adjacent to the camping unit 10 and provides shade. The shade structure 46 comprises basically a shade support 47 that pivots up from the housing 12, and a flexible shade sail 48 extending from the shade support 47, which provides a shaded area adjacent to the camping unit 10. The shade structure 46 further includes two or more support posts 49 mounted on the ground 102 and supporting the shade sail 48 at points spaced from the housing 12. The shade structure 46 is shown in FIG. 1 in a folded form and, in FIG. 13A (which relates to a second embodiment described in more detail below), it is shown in a fully deployed configuration.

The housing 12 further includes a power management system including a control panel 40 that can be inspected and controlled by a user standing in front of the housing 12. The control panel 40 provides controls for operating the appliances or amenities in the housing 12, e.g. the cook top 32. The camping unit 10 also includes a battery (not shown) mounted on or in the housing 12 that can be used to energize electrical appliances or services on the unit 10. The camping unit 10 also includes an electrical power connector (not shown) for coupling the camping unit to an external power supply for powering appliances and amenities on the camping unit and charging the battery.

The vehicle or camping unit mounting arrangement 16 comprises a hitch 70 for coupling up to a hitch receiver 170 on the camping vehicle or tow vehicle 100, and a housing mount 72 that can be spaced from the hitch receiver 170 on which the camping unit housing 12 is mounted. It also includes a displacement mechanism 74 intermediate the hitch 70 and the housing mount 72 or unit housing 12 for displacing the housing mount 72 away from the hitch 70. The vehicle or camping unit mounting arrangement 16 is interchangeable between a travelling configuration where the unit housing 12 is positioned adjacent to the tow vehicle 100 on which it is mounted and a camping configuration in which the housing 12 is displaced away from a rear 114 of the tow vehicle 100 to provide access to a rear door of the vehicle 100.

In this embodiment the hitch 70 comprises a male member for insertion into a female hitch receiver 170 on the camping vehicle 100 whereby to operatively couple the camping unit 10 to the camping vehicle 100. In the illustrated embodiment, the female hitch receiver 170 comprises a rectangular tube having a rearward facing open end. The male hitch 70 comprises a rectangular tube that is sized to be received within the female hitch receiver 170 with a working clearance which facilitates a sliding fit of the male hitch 70 within the female receiver 170. Further, the female receiver 170 can be packed with shims and spacers to provide for a tighter fit which limits movement of the hitch 70 within the hitch receiver 170. In the illustrated embodiment shown in FIGS. 1 to 4, the housing mount 72 comprises a plate mounted on a free end of the second arm 82.

In this embodiment, the displacement mechanism 74 of the vehicle or unit mounting arrangement 16 comprises two arms 80, 82 articulating relative to each other and optionally also the hitch 70 and the vehicle mount 72. A first arm 80 is mounted on the vehicle 100 and the remote end is mounted to a second arm 82. The remote end of the second arm 82 in turn has the housing mount 72 (and camping unit housing 12) mounted on the remote end thereof, e.g. pivotally so that it can be turned relative to the second arm 82. This enables the camping unit housing 12 to be pivoted away from a rear 114 of the vehicle 100 on which it is mounted with two degrees of freedom. For example, the camping unit housing 12 can be pivoted into a position in which it extends along a side of the vehicle 100 away from the rear of the vehicle 100 as shown in FIG. 4. This feature is very convenient because it permits a user to access a rear door or tailgate of the vehicle 100 when the camping unit 10 is in a camping configuration.

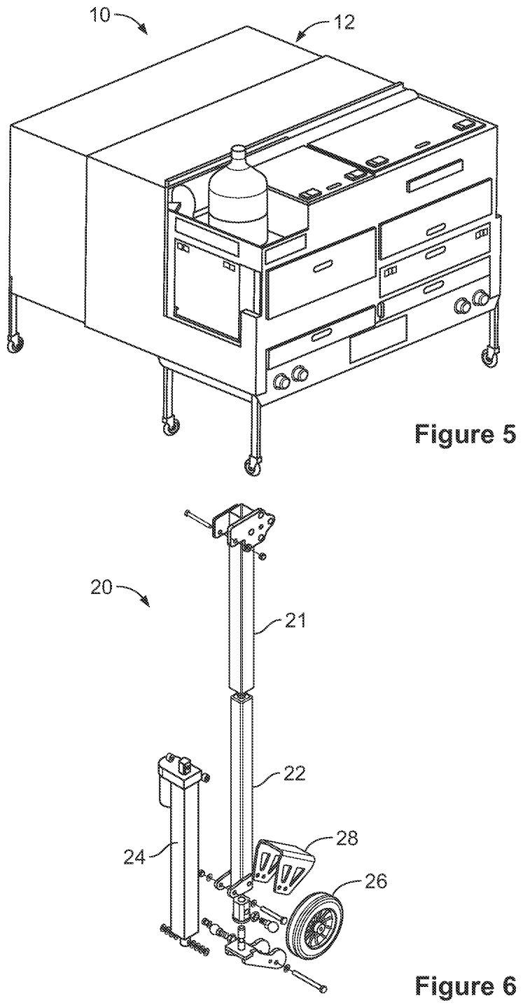

Further, as shown in FIG. 5 of the drawings, the camping unit housing 12 in at least one form comprises inner and outer housing sections 12A and 12B that are telescopically displaceable relative to each other in a direction from front to rear. This enables the housing 12 to be changed between a nested configuration where the sections 12A and 12B substantially overlap with each other, and an extended configuration where the sections 12A and 12B are extended whereby to create a new internal space or void formed by 12B. The new internal space may have a roof cover and at least some side walls and the Applicant believes that it may provide a sheltered sleeping space or zone during camping. At the same time, several other uses would readily be recognized by a person skilled in the art and this internal space may also be used for other purposes.

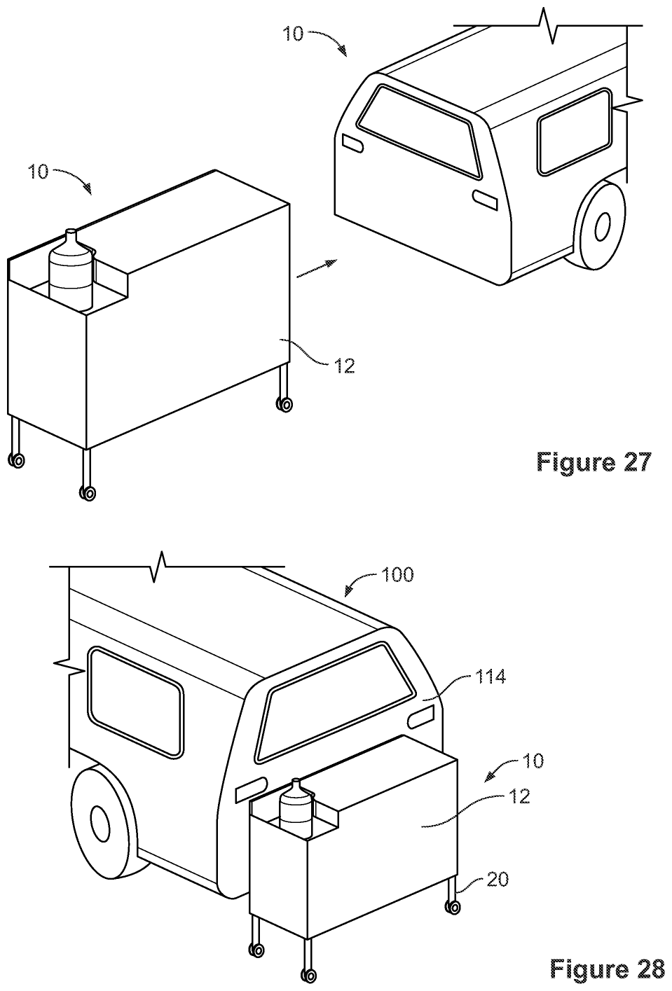

In use, the camping unit 10 is first mounted onto a camping vehicle 10 prior to a trip. To do this, the camping unit 10 is wheeled from its storage position in a garage or the like up to the rear 114 of the vehicle 100. The height of the camping unit 10 can be adjusted by a user to suit or match the height at which it will be mounted on the vehicle 100. This is done by means of the independently adjustable support legs 20 which support the unit 10 on the support surface. As described above, each support leg 20 is driven by an independent drive arrangement (not shown) provided by a linear actuator 24 driven by an electric motor. This is shown in FIG. 27.

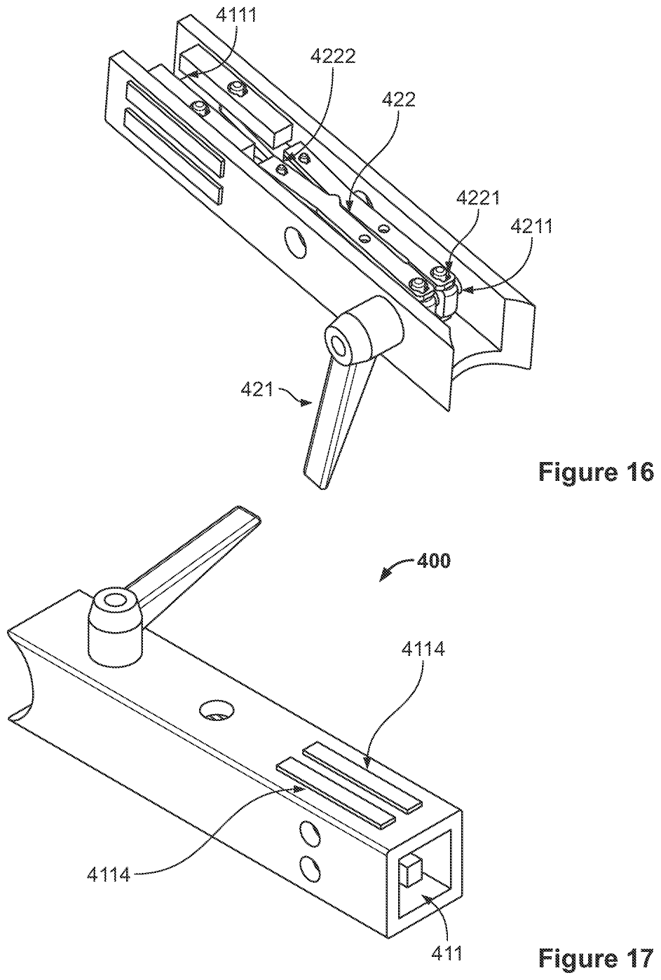

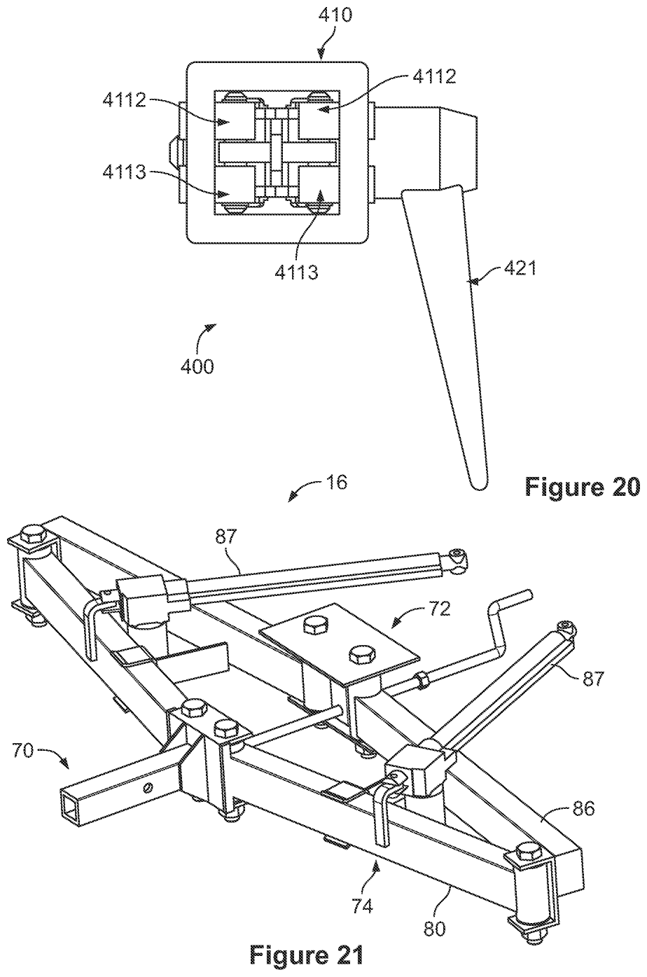

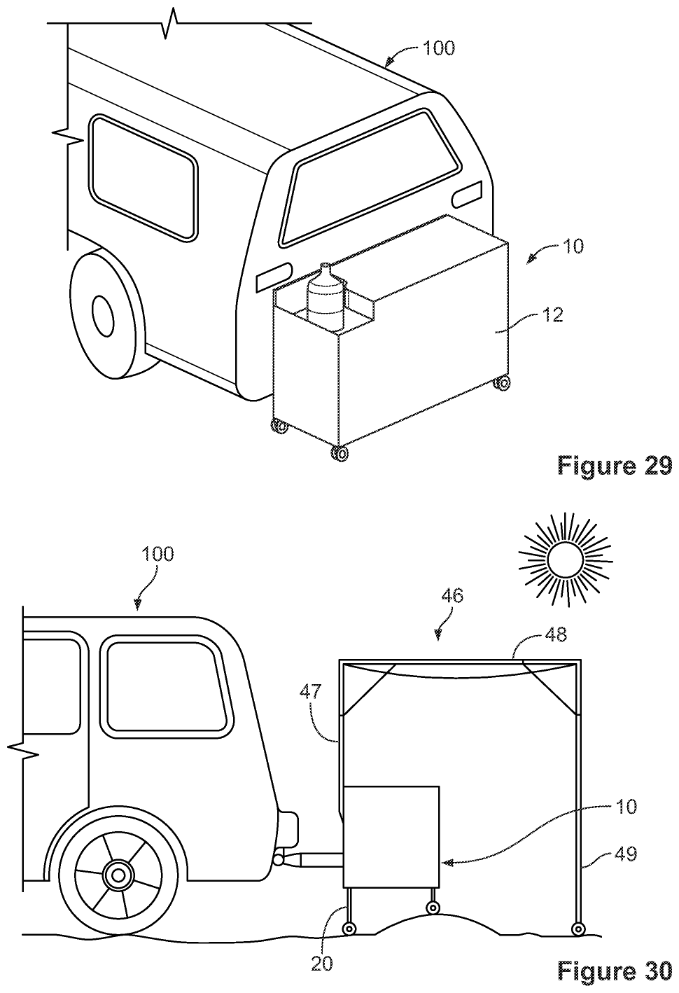

The camping unit 10 can then be mounted onto the vehicle 100. This is done by inserting the hitch 70 on the camping unit mounting arrangement 16 into the female hitch receiver 170 on the vehicle 100. The camping unit 10 is then supported (or carried) by the vehicle 100 and is completely off the ground 102 as shown in FIG. 28. The hitch 70 is locked to the hitch receiver 170 with the unit 10 in a travelling position in the manner shown in FIGS. 15 to 20, and the legs 20 can be retracted or withdrawn into the housing 12. The camping unit 10 is mounted on the vehicle 100 in a compact travelling configuration suitable for road travel as shown in FIG. 29.

The camping unit 10 is then typically packed with supplies for a camping trip. This packing can also be done before the unit 10 is physically mounted up on the vehicle 100 as well. In particular, the water tank 45 can be filled with water, and food and other supplies can be placed in the various storage zones and drawers 44 on the housing 12 described above.

The camping vehicle 100 with camping unit 10 thereon is then ready for travel to a camping or recreation site. The vehicle 100 is driven on the road in a normal way and the camping unit 10 forms a compact rectangular box type housing 12 mounted up against the rear of the vehicle 100 and does not hinder or complicate driving of the vehicle 100 in any way. While the unit housing 12 does project back from the rear 114 of the vehicle 100, its depth in a rear direction is not appreciable.

When the vehicle 100 arrives at a place for recreation, the camping unit 10 can be converted from a travelling to a recreational camping configuration. To do this, the camping unit 10 can be unlocked and displaced away from the rear of the vehicle 100. This is done manually by swinging the first arm 80 away from the rear of the vehicle 100 and then swinging the second arm 82 relative to the first arm 80.

The support legs 20 on the housing 12 can also be extended down into a position where they bear up against the support surface 102, e.g. the ground. The lowered legs 20 then carry some of the weight of the camping unit 10 so the weight is not solely borne by the camping vehicle 100. Once again, this can be done by means of the independent drive arrangement, e.g. actuators 24, on each of the support legs 20.

Further, the levelling arrangement 50 can be used to level the housing 10 as shown in FIG. 29, including the working counter surface 30 on the housing 12, so that the unit 10 has nice convenient horizontal surfaces for working on, irrespective of the orientation or slope of the vehicle 100 and terrain on which the legs 20 are placed. It will be appreciated that very often the ground or terrain at a camping site is not even and consequently the camping vehicle 100 may not stand horizontally on the ground 102. Notwithstanding this, the levelling arrangement 50 enables the camping unit 10 to be levelled to provide a horizontal working surface to despite the uneven camping terrain.

The various shelves and zones of the camping unit 10 can then be opened for recreational use as shown in FIGS. 1 and 5 particularly. For example, the cook top 32 and the wash basin 34 on the upper surface of the housing 12 can be opened for use. The drawers 44 can also be pulled open to gain access to items stored or kept in the shelves. The barbeque 42 can also be displaced out of the housing 12 thereby opening the barbeque 42 for use.

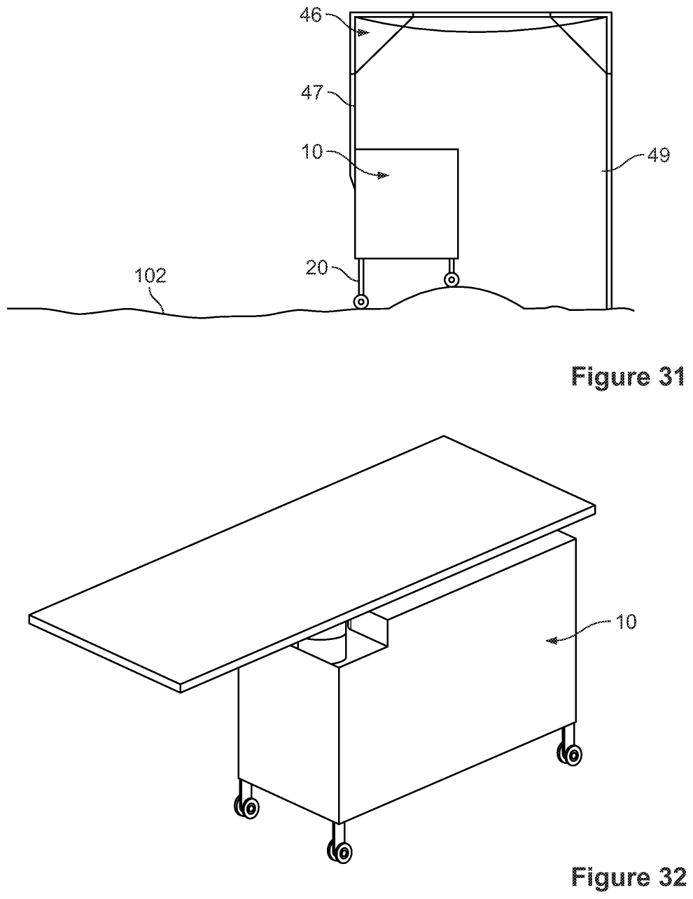

Further, the shade structure 48 can be pivoted up away from the top surface of the housing 12 in the manner shown in FIG. 1 deploying the shade sail 48 to provide shade near the camping unit 10 in a similar manner to that shown in FIG. 13B. This is also shown in FIGS. 30 and 31.

When campers desire to pack up and leave a camp site (and they have finished using the camping unit 100 in its camping configuration), the camping unit 10 is mounted up on the rear of the vehicle 100 in its travelling configuration. This process is quick and easy and does not take much time or effort because the unit 10 is either, still operatively mounted on the vehicle 100, or easily remounted again on the vehicle 100. The vehicle 100 can then be driven to its next location.

At the end of a camping trip, the camping unit 10 can be dismounted and detached from the vehicle 100 and stored away until its next use. To do this, the support legs 20 with wheels are deployed to support the camping unit 10 above the support surface 102 independently of the vehicle 100. The hitch 80 can then be withdrawn from the hitch receiver on the vehicle 100 separating the unit 10 from the vehicle 100. The unit 10 can then be wheeled on its support legs 20 with wheels across the support surface 102 to a storage position. For storage, the camping unit 10 can be lowered to a storage position that is lower and more compact than the height at which it is unloaded from the vehicle 100. This activity is shown in FIG. 32 where the legs are shortened to enable the camping unit 10 to fit beneath a shelf in a storage zone.

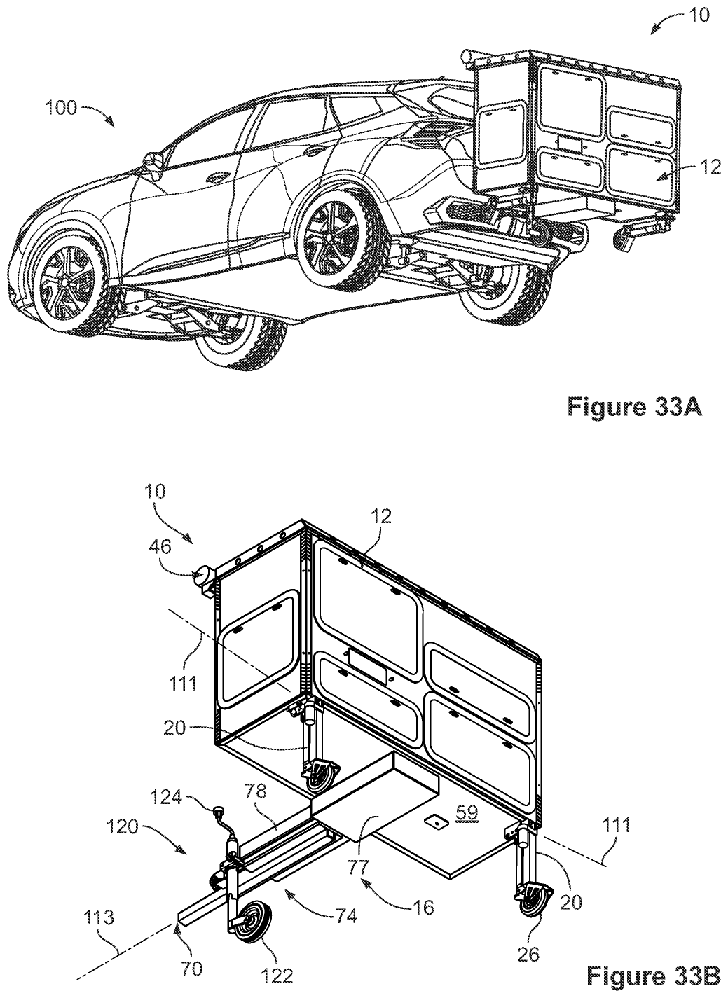

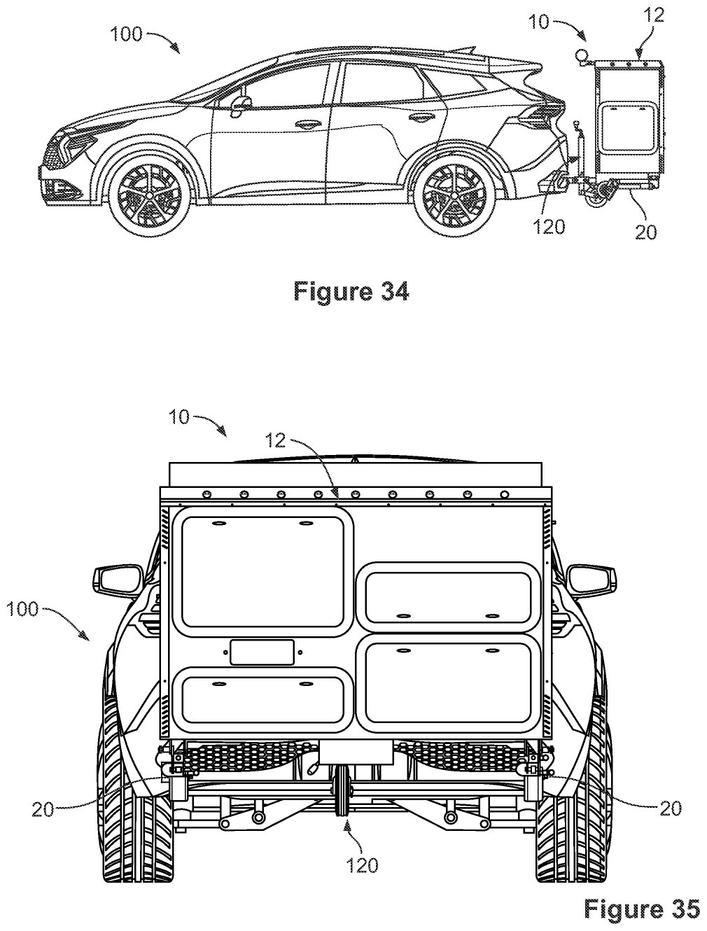

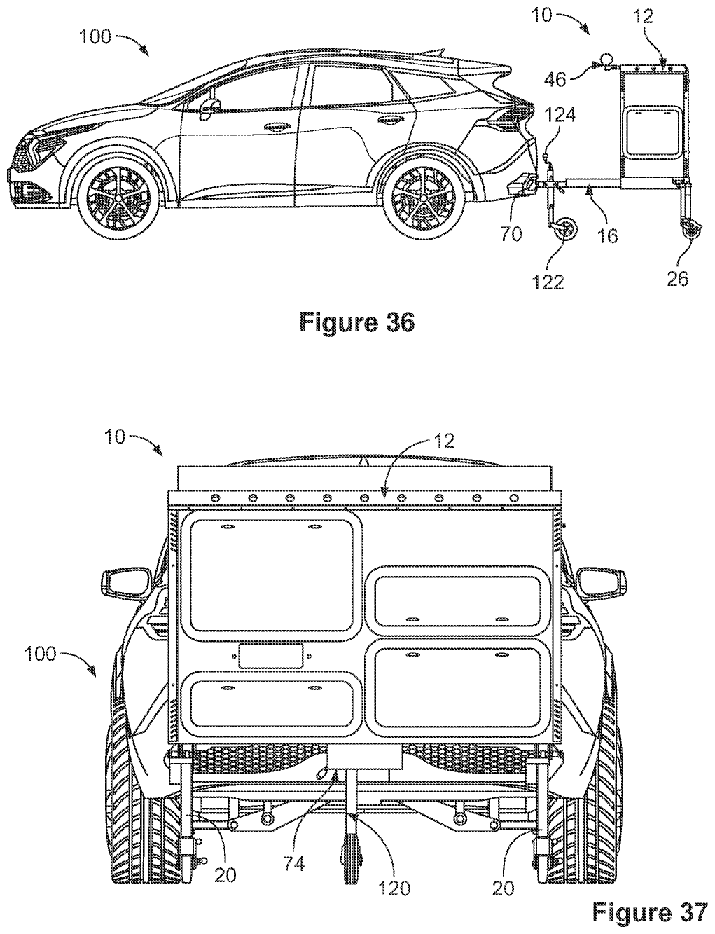

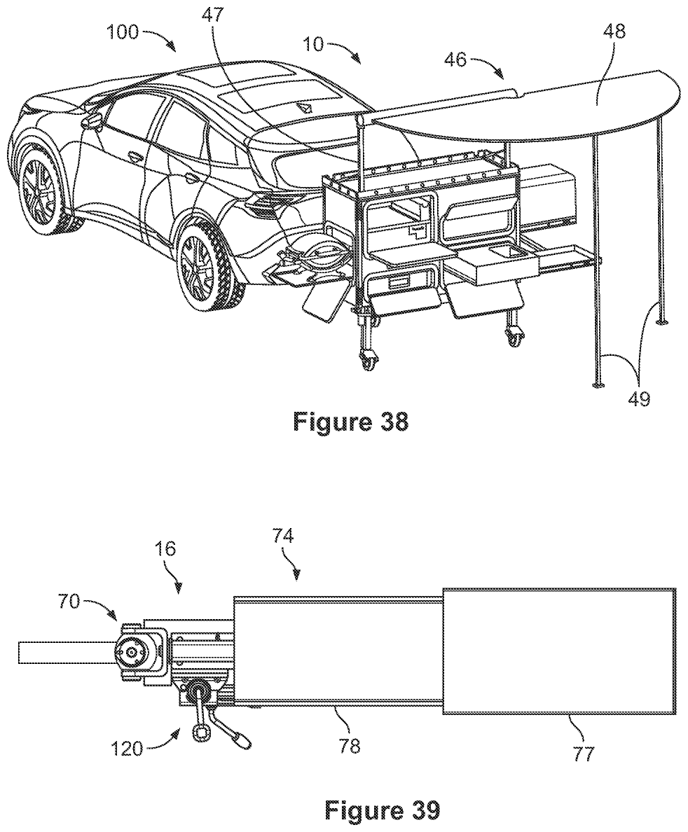

FIG. 33A to 38 illustrate a vehicle mounted service unit or camping unit in accordance with another embodiment of the invention. As this embodiment has similarities with the earlier embodiments described above, the same reference numerals will be used to refer to the same components unless otherwise indicated. Further, the following description will emphasize the differences between this embodiment and the earlier embodiments.

FIGS. 33A to 35 illustrate the camping unit 10 in its travelling configuration mounted on a tow vehicle 100 that is suitable for travel on a support surface 102 that is a road. In this configuration, the components of the camping unit 10 are retracted above the support surface 102 on which the tow vehicle 100 is travelling.

Broadly, the camping unit 10 comprises a unit housing 12 for providing amenities used in camping activities, and a vehicle or unit mounting arrangement 16 on which the unit housing 12 is mounted. The vehicle mounting arrangement 16 comprises a tow hitch 70 that is configured for operatively coupling the camping unit 10 to a tow vehicle 100.

The camping unit 10 further comprises a first retractable support leg 20 and a second retractable support leg 20 mounted on the unit housing 12, the first and second retractable support legs 20 being laterally spaced from each other on the unit housing 12 and defining a transverse leg axis 111 therebetween.

The first and second retractable support legs 20 are configured to support the camping unit 10 on the support surface 102 while it is operatively coupled to the tow vehicle. The support legs 20 can also independently support the camping unit 10 when it is uncoupled from and detached from the tow vehicle 100. The camping unit 10 further comprises a jockey wheel 120 mounted on the vehicle mounting arrangement 16 that is spaced from the transverse leg axis 111.

Each of the components of the camping unit 10 will be described in more detail below.

Each retractable support leg 20 can be independently extended or shortened for the purpose of adjusting the height of the unit housing and for levelling the unit housing. To achieve this each leg 20 comprises two leg sections 21, 22 that are axially displaceable relative to each other, and a linear actuator 24 for selectively driving displacement of the leg sections 21 and 22 relative to each other. Further, each retractable support leg 20 has a wheel 26 at a lower end thereof for running on the support surface 102.

The vehicle mounting arrangement 16 comprises an axial tow axis 113 extending from the tow hitch 70 to the unit housing 12, and the jockey wheel 120 is mounted on or adjacent to the axial tow axis 113. Thus, as shown in the drawings, the jockey wheel 120 is substantially centrally positioned across a width of the unit housing 12.

The axial tow axis 113, in turn, extends orthogonally to the transverse leg axis 111 which passes through the first and second retractable support legs 20. The first and second retractable support legs 20, in turn, are laterally aligned with each other and are positioned equidistant from a centre line passing through the unit housing 12.

The jockey wheel 120 has a leg and a wheel 122 at a lower end of the leg. The height of the jockey wheel 120 is manually adjustable by means of a handle 124. The height of the jockey wheel 120 is adjusted by turning the handle 124 and rotation in one direction raises the height of the jockey wheel, while rotation in an opposite direction lowers the height of the jockey wheel. The jockey wheel 120 is used in this way to adjust the orientation or angle of inclination of the unit housing 12 in a direction perpendicular to the transverse leg axis 111 extending between the first and second retractable support legs 20.

Further, as with the first embodiment described above, the vehicle mounted camping unit 10 includes a surface orienting arrangement 50 for orienting a surface of the unit housing 12. Typically, this will be a horizontally extending surface of the housing such as a bottom wall or floor 59 of the unit housing 12. The surface orienting arrangement 50 acts to orient said surface 59 of the unit housing 12 so that it is horizontal in a direction along the transverse leg axis 111 extending between the first and second support legs 20.

The surface orienting arrangement 50 comprises a sensor 52, which in at least one embodiment, is in the form of an accelerometer. The sensor 52 senses an angle of the surface 59 on the unit housing 12 in the direction along the transverse leg axis 111. It further comprises a controller 54 that is operatively connected to the sensor 52 for receiving sensing information from the sensor 52. The controller 54 is also operatively connected to the first and second retractable support legs 20 to independently adjust the length of each of the first and second retractable support legs 20.

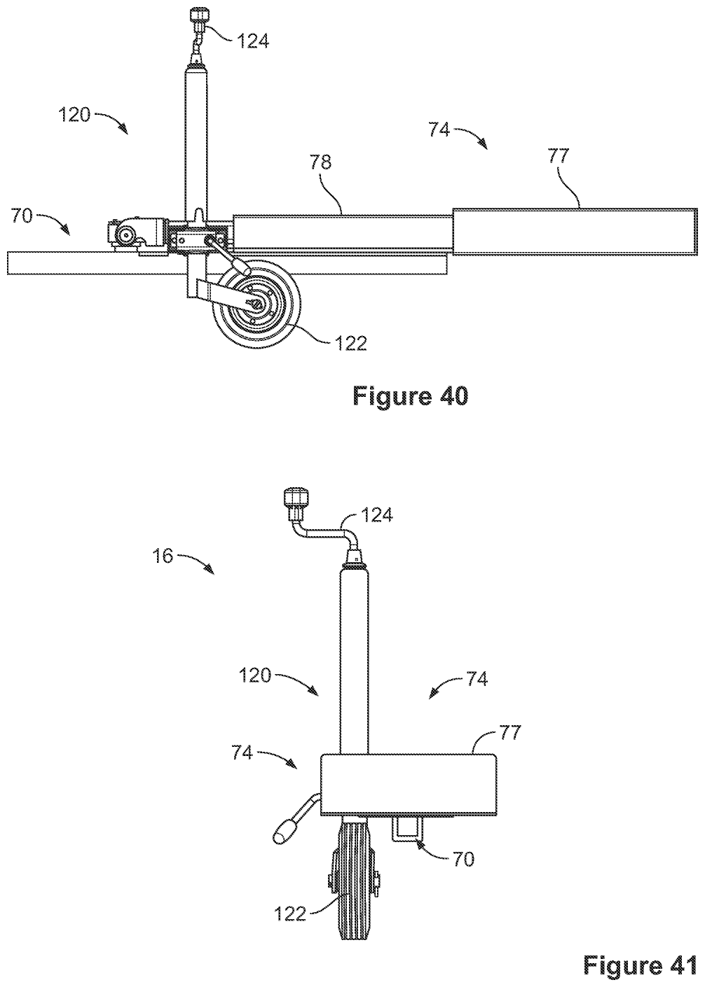

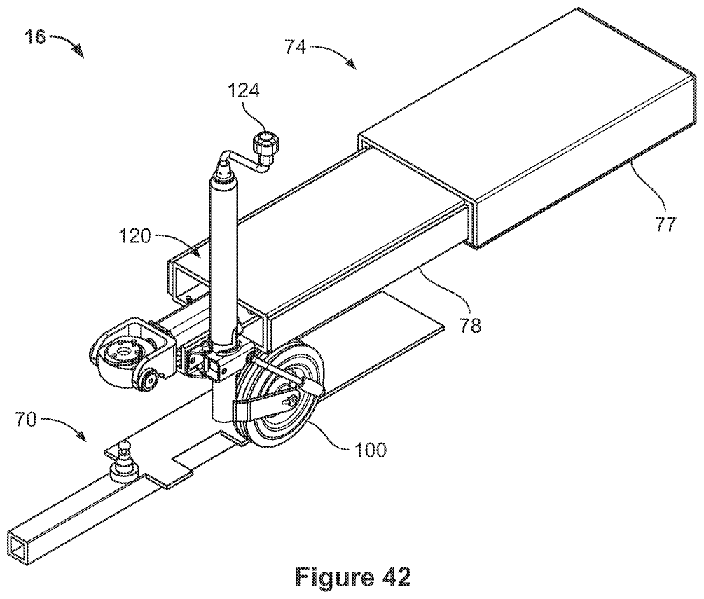

FIGS. 39 to 42 illustrate in detail the vehicle mounting arrangement 16 for operatively coupling the camping unit 10 to a hitch receiver 170 of the tow vehicle 100. These drawings have some parts omitted to show as much of the structure and functioning of the vehicle mounting arrangement 16 as possible.

The vehicle mounting arrangement 16 on which the unit housing 12 is supported comprises the hitch 70 which is coupled to the hitch receiver 170 on the tow vehicle 100. It further comprises a slide mechanism or slide arrangement 74 extending from the hitch 70, that displaces the unit housing 12 between a travelling configuration where it is adjacent to the hitch 70 and an extended camping configuration in which the unit housing 12 is spaced away from the hitch 70.

In the illustrated embodiment, the slide mechanism 74 comprises at least first and second telescoping slide members 77 and 78 that slide axially relative to each other to displace the unit housing 12 between the travelling and camping configurations. The unit housing 12 is fixedly mounted directly on the first telescoping slide member 77 of the slide mechanism 74 by means of fasteners such as bolts such that it is fast therewith.

In the illustrated embodiment, the unit housing 10 is manually displaced between the travelling and camping configurations. To accomplish this, one or more users physically push the unit housing 12 away from the hitch receiver 170 on the tow vehicle 100.

Further, the hitch 70 used in this embodiment is configured so that it can pivot in one dimension from one side to another side on the hitch receiver 170. It is also able to pivot up and down on the hitch receiver 170. This enables the vehicle mounting arrangement 16 to orient in two dimensions relative to the tow vehicle 100 and hitch receiver 170 to which it is operatively coupled.

This feature enables the unit housing 12 to be mounted directly on the slide mechanism (without any movement of the unit housing relative to the slide mechanism) because the tow hitch 70 above can accommodate some differences in orientation between the tow vehicle 100 and the unit housing 12 in two dimensions. This type of hitch 70, which can pivot in two dimensions, is commercially available and may be purchased off the shelf. This feature enables the hitch to accommodate the camping unit being oriented at a different orientation to a tow vehicle.

In use, the vehicle mounted camping unit 10 is towed by a tow vehicle 100 to where it is required in the travelling configuration.

When it arrives at its destination, the camping unit 10 and specifically the unit housing 12 can be changed into the camping configuration. To do this, the unit housing 12 is displaced away from the tow hitch 70, and the tow vehicle 100 using the slide mechanism 74.

Each of the first and second support legs 20 can then be extended into engagement with the support surface 102, which is typically the ground. The jockey wheel 120 can also be extended to support the camping unit 10.

In some situations, the tow vehicle 100 needs to be inclined at a slightly different angle to the camping unit 10, e.g. due to unevenness in the terrain. To accommodate this the camping unit can incline relative to the tow vehicle 100 because the hitch is able to tilt in two dimensions relative to the tow vehicle. This enables the unit housing 12 to be oriented differently to the tow vehicle 100 even though the unit housing is fixedly mounted on the vehicle mounting arrangement 16 and cannot tilt thereto.

Further during use in the camping configuration, the camping unit 10 can also be detached from the tow vehicle and stand independently on the ground.

The first and second retractable support legs 20 can be adjusted to level the unit housing 12 in one dimension, namely along the transverse leg axis 111. The sensor 52 senses the orientation of the surface 59, and the controller 54 then independently adjusts the lengths of the first and second legs 20 to level the surface 59 along said one dimension being the leg axis 111. The user then manually adjusts the jockey wheel 120 to level the unit housing 12 in a dimension that is orthogonal to the first dimension. Applicant has found that manual adjustment of the jockey wheel 120 can level the camping unit 10 with a sufficiently fine tolerance to provide level surfaces on the unit housing 12 suitable for preparing food and camping use generally.

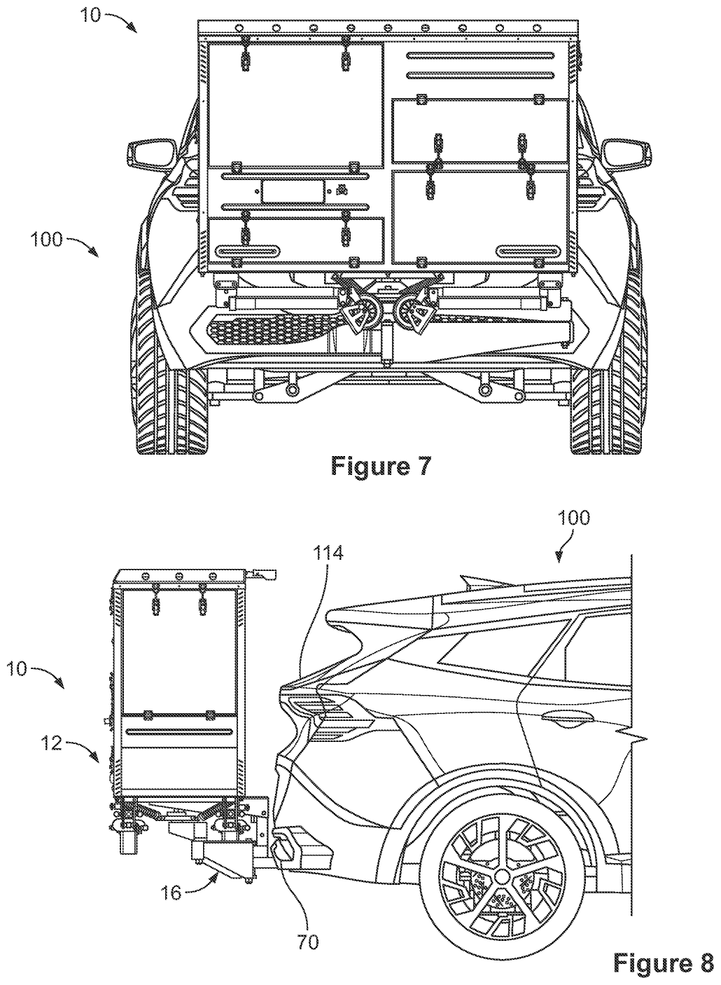

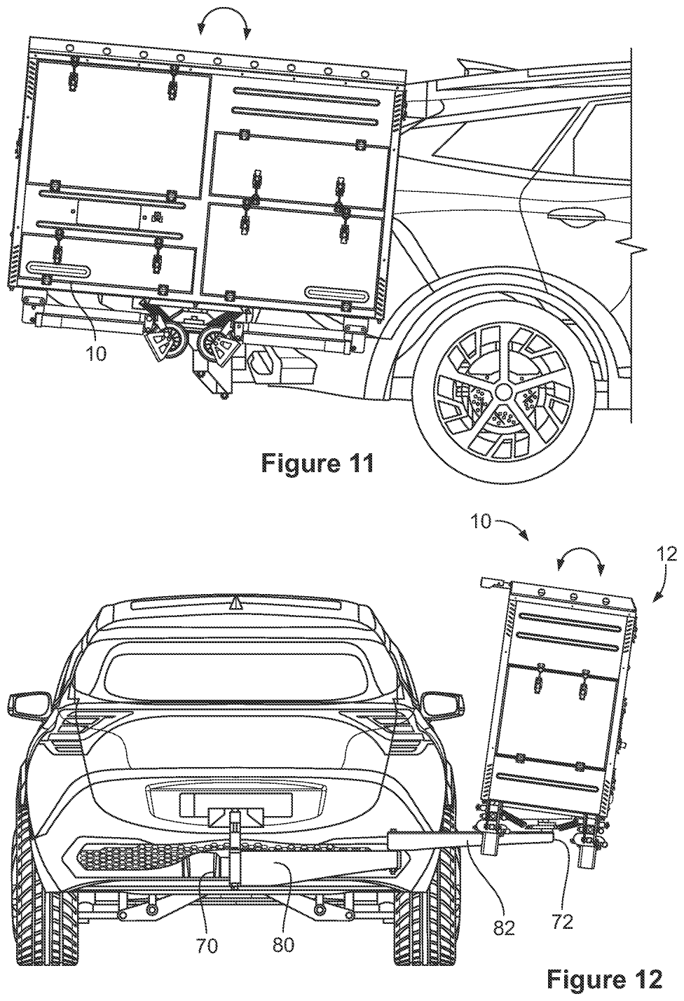

FIGS. 7 to 13 illustrate a vehicle mounted camping unit in accordance with another embodiment. The camping unit in these drawings has some similarities with the camping unit described above with reference to FIGS. 1 to 7 and, unless otherwise indicated, the same reference numerals will be used to refer to the same components.

Overall, the housing 12 of the camping unit 10 is like the housing described above with reference to FIGS. 1 to 7. The unit 10 has compartments and zones for camping amenities, such as a wash basin, a cooking plate, a barbeque, and a camping refrigerator. While the layout of the housing may be different to that in FIG. 1, the types of amenities provided and their arrangement on the housing, is quite similar.

Broadly, the unit or vehicle mounting arrangement 16 comprises a hitch and a spaced housing mount on which the camping unit housing is mounted, and a mounting displacement mechanism intermediate the hitch and the housing mount. However, the mounting arrangement 16 in this embodiment is different to that described above with reference to FIGS. 1 to 7.

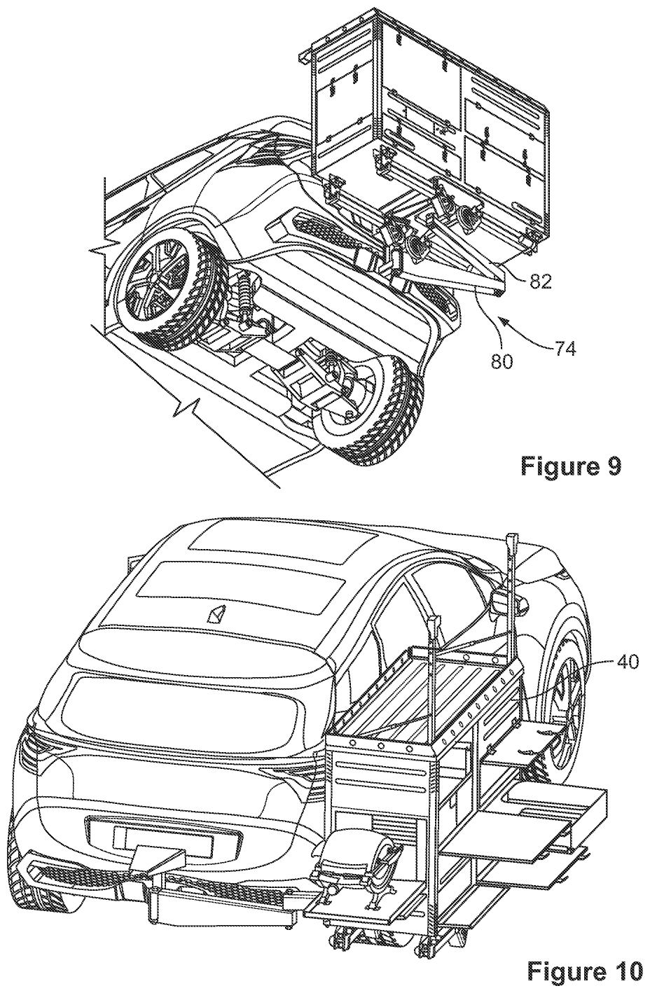

The vehicle or unit mounting arrangement comprises a mounting component in the form of mounting device 300. Mounting device 300 is best shown seen in FIG. 9. Mounting device 300 comprises a first arm 310; and a second arm 320. First arm 310 comprises a first end 311; and a second end 312. A first end 311 of first arm 310 comprises a hinge portion 311, pivotally connected to hitch attachment device 400 described in further detail below. A second end 312 of first arm 310 comprises hinge portion 312 pivotally connected to second arm 320.

The second arm 320 comprises a first end 321, and a second end 322. The first or outer end 321 of the second arm 320 is rotatable and tiltable with respect to a base support 330 which is part of the mounting device 300. Second or inner end 322 of second arm 320 comprises hinge portion 3221 pivotally connected to first arm 310.

The base support or housing support 330 is rotatable and tiltable to first or outer end 321 of second arm 320 by a ball joint or spherical bearing arrangement 333. The base support 330 comprises an apparatus body mounting plate 331 to which apparatus housing or body 300 is fixed in the camping unit or apparatus as depicted in FIGS. 7 to 13. More particularly, apparatus body 300 is fixed to an upper face 3311 of mounting plate 331. The base support 330 further comprises a trapezoidal receiving frame 332. Receiving frame 332 is attached to a lower face 3312 of the mounting plate 331.

Resiliently flexible members 340 in the form of two heavy duty coil springs are connectable between respective outer edges of apparatus body mounting plate 331 and second arm 320.

Receiving frame 332 is engageable with insertion body 350. The insertion body 350 can be inserted into the receiving frame 332, and connection between the receiving frame 332 and the insertion body 350 can be secured with latch mechanism 3321. The insertion body 350 is attached to the hitch attachment device 400 by mounting member 351.

Mounting device 300 can be used to configure apparatus 30 between travel and camping configurations in a similar manner as hereinabove described in relation to the unit mounting arrangement 16 of the camping unit 10. Insertion body 350 is received by the receiving frame 332 in the travel configuration. Release of insertion body 350 from receiving frame 332 facilitates configuring apparatus 30 to the accessibility configuration.

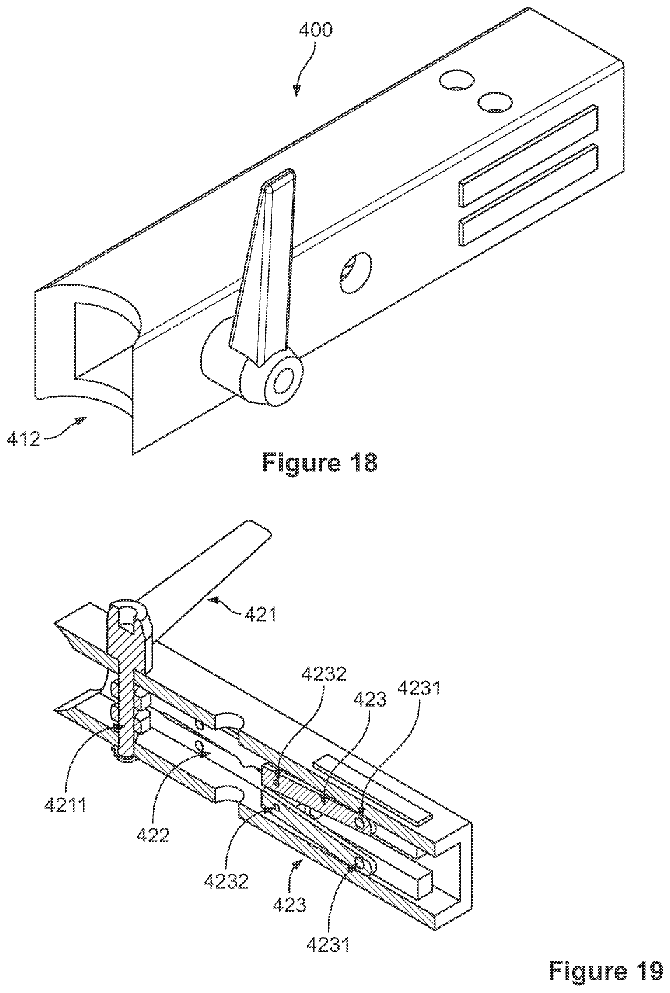

Notably, pivotal connection of first end 311 of first arm 310 to hitch attachment device 400 in conjunction with pivotal connection of second end 312 of first arm 310 to second arm 320 and rotatable connection of the apparatus body or housing to second arm 320 via ball joint arrangement or spherical bearing 333 and base support 330 facilitates movement of apparatus body 300 between: (a) a position perpendicular to a back of a vehicle to which apparatus 30 is mounted; (b) a position perpendicular to a first or right side of the vehicle (shown in FIG. 18); and (c) a position perpendicular to a second or left side of the vehicle (shown in FIG. 23).

Notably, the ball joint arrangement 333 facilitates not only rotatable but also tiltable movement of apparatus body relative to second arm 320. Connectable springs 340 can be connected between base support 330 and second arm 320 to stabilize tiltable movement of apparatus body relative to second arm 320.

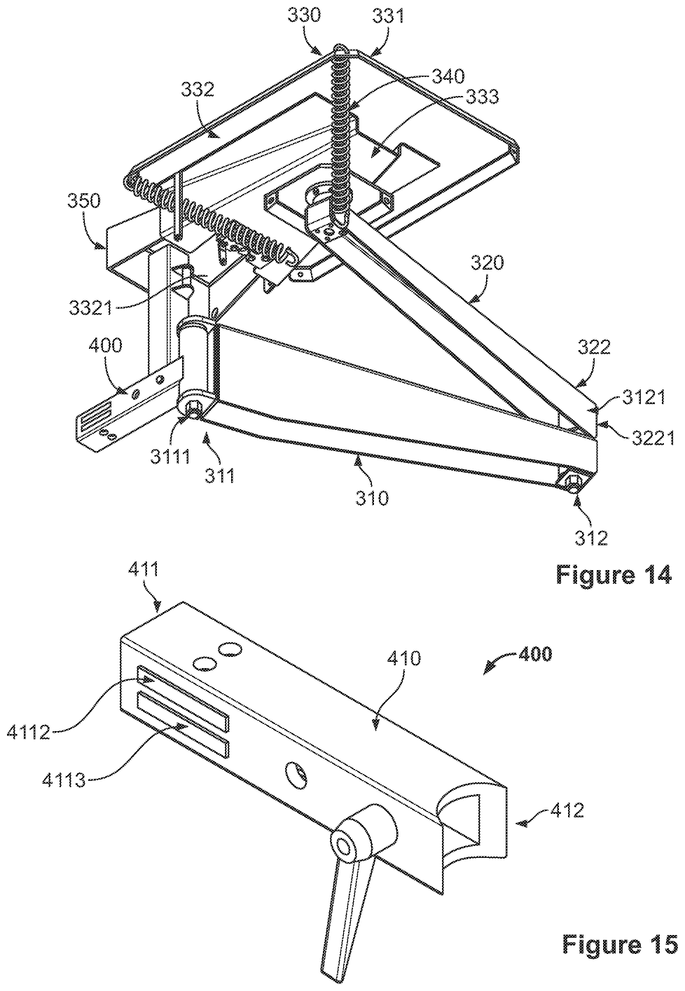

As shown in FIGS. 7 to 12, the mounting device 300 is attached to a tow hitch of vehicle using a hitch and hitch receiver device 400 which is shown in FIGS. 14 to 20.

Hitch attachment device 400 comprises hitch attachment device body 410 comprising hitch attachment end 411; and mounting device attachment end 412. As shown in FIG. 14, mounting device attachment end can form part of a hinged connection with a mounting device such as a mounting device 300.

Hitch attachment device 400 further comprises releasable hitch gripping mechanism 4111 internally within open hitch attachment end 411. Hitch gripping mechanism 4111 comprises upper and lower paired jaw portions 4112 and 4113. The jaw portions 4112 and 4113 are shaped substantially as rectangular prisms and inset into respective slots 4114 of sides of 413 and 414 of hitch attachment device body 410, located towards hitch attachment end 411.

Hitch attachment device 400 further includes an actuator 420 in the form of a ratcheting mechanism. It will be appreciated that ‘ratcheting mechanism’ is being used broadly herein to refer to mechanisms such as actuator 4200 which, until actively released, are constrained to move in a tightening direction only and are prevented from (or at least strongly resist) substantial loosening.

Ratcheting mechanism 420 comprises handle 421, ratcheting legs 422, and ratcheting feet 423. First ends 4221 of ratcheting legs 422 are connected to handle 421 via nut and thread arrangement 4211. Second ends 4222 of ratcheting legs 422 are pivotally connected to second ends 4232 of ratcheting feet 423. First ends 4231 of ratcheting feet 423 are pivotally connected centrally within respective upper and lower jaws of paired jaw portions 4112 and 4113.

In use, actuation of the handle 421 in a gripping direction closes respective upper and lower jaws 4112 and 4113 via the ratcheting legs 422 and the ratcheting feet 423, such that a portion of a tow hitch or the like can be firmly gripped therebetween. Further, actuation of the handle 421 in a releasing direction opens respective upper and lower jaws 4112 and 4113 via ratcheting legs 422 and ratcheting feet 423, such that the portion of the tow hitch or the like can be released from the gripping jaws.

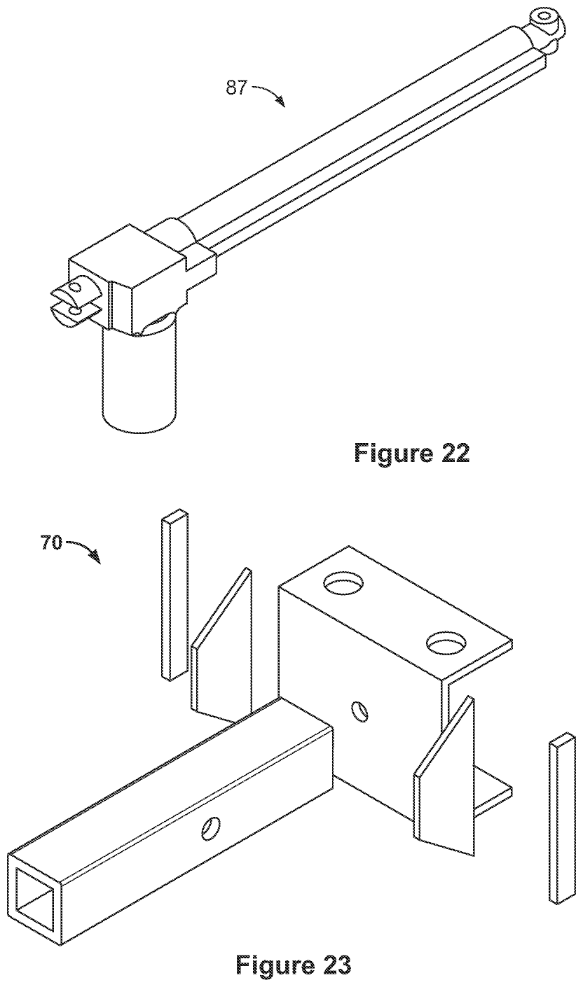

FIGS. 21 to 23 illustrate part of a camping unit in accordance with another embodiment of the invention having a different vehicle or camping unit mounting arrangement to that in FIGS. 1 to 7. This camping unit mounting arrangement will be described below, and the description will focus on the differences between this embodiment and the earlier embodiment.

The camping unit mounting arrangement 16 comprises a hitch 70, and a housing mount 72 on which the camping unit housing 12 is mounted, and a mounting displacement mechanism 74 intermediate the hitch 70 and the housing mount 72.

In this embodiment, the mounting displacement mechanism 74 comprises a folding parallelogram linkage in which the linkage members 86 can be folded between a collapsed configuration and an expanded configuration. It also includes an actuator 87 for driving the housing mount 72, and housing 12 mounted thereon, outward away from the hitch 70 and an associated rear 114 of the tow vehicle 100.

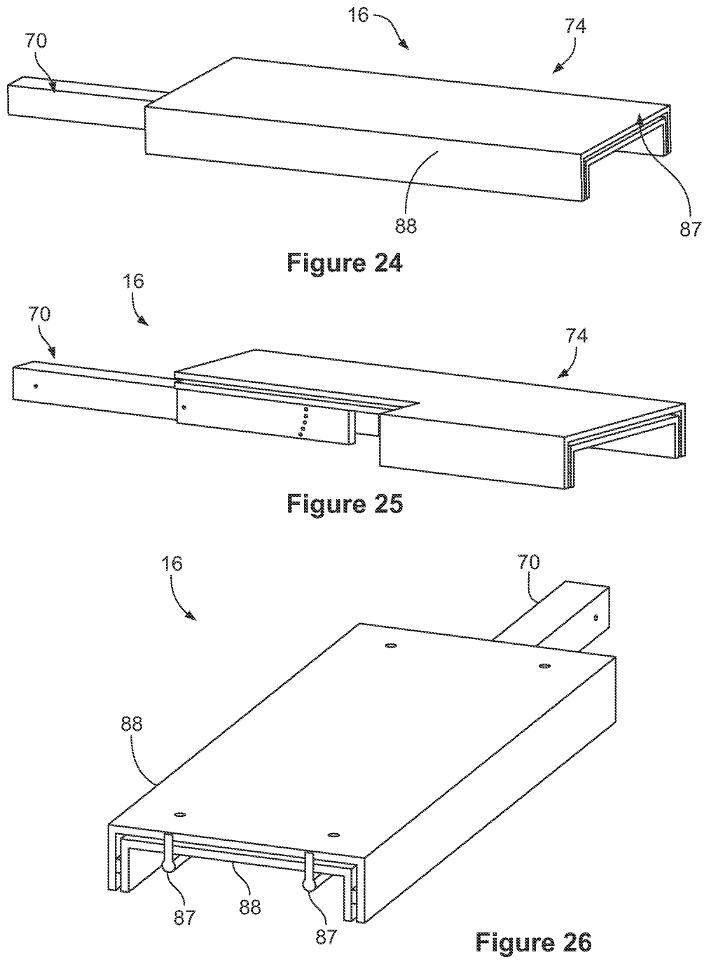

FIGS. 24 and 25 illustrate a camping unit 10 that is a variation on the camping unit described above with reference to FIGS. 21 to 23. This description will focus on the differences between this embodiment and the earlier embodiment.

In this form, the mounting displacement mechanism 74 comprises a slide mechanism comprising a plurality of slide members 88 that are engaged with each other yet can slide relative to each other in an axial direction. The slide members can slide relative to each other in a direction that displaces the housing mount 72 away from the hitch 70. The slide members 88 extend linearly away from the hitch 70 in a rearward direction whereby to displace the housing mount 72 in a direction linearly away from the hitch 70. This provides access to the rear 114 of the vehicle 100 enabling a user to open a rear door of the vehicle. The slide mechanism is simple and can be made with sufficient strength to support the camping unit housing at a distance spaced from the hitch.

An advantage of the hitch mounted camping unit described above with reference to at least some of the drawings is that it provides a compact camping unit with camping amenities (e.g. that are required for a camping holiday) that is mounted directly on a vehicle and does not form a separate vehicle that is towed. The amenities on the illustrated camper trailer are comparable to those on a camper trailer and can provide a very comfortable camping experience.

Another advantage related to the first advantage above is that a camping unit can be provided at a significantly lower cost than a camper trailer. Applicant estimates that the camping unit can be built at less than half of the cost of a camper trailer while still providing many of the same amenities. For example, a camper trailer requires a chassis and a set of four wheels whereas a camping unit does not require these road engaging wheels because it is mounted up on its carrying vehicle. Further, a camping unit has a smaller overall size and therefore consumes less materials when it is being built.

Further, it is considerably easier and cheaper to operate a directly mounted camping unit rather than a camper trailer which is a separate vehicle. A vehicle has licence fees and needs to be maintained. Yet further, Applicant submits that travelling with a camping unit is generally safer than a camper trailer that is an independent vehicle.

The camping unit has a very compact footprint for storage and therefore only occupies a small amount of space. By contrast, a camper trailer also needs to be stored somewhere and needs considerable space for storage because it is a separate vehicle. A camper trailer occupies a space that is comparable to a large vehicle or even a caravan.

Yet further, a camping vehicle having the camping unit mounted thereon is easier to drive than a drive vehicle towing a camper trailer. A vehicle towing a camper trailer is much longer than a vehicle with camping unit and this complicates travel. It is also heavier as the camper trailer also adds considerable additional weight to the combined vehicle and trailer weight that needs to be towed.

Applicant also makes the point that the camping unit is more convenient than a camper trailer because once it is mounted on a vehicle, it generally stays mounted on the vehicle for an entire trip. It is not uncoupled and then reconnected up to the vehicle at each camping site. It simply stays mounted on the vehicle and is selectively interchanged between travelling and camping configurations as required. Further, as the camping unit is able to be displaced away from the rear of the vehicle providing access to a rear door or tailgate of the vehicle, it does not limit access to an interior of the vehicle.

It is highly desirable that the working surfaces on a camping unit, e.g. for preparing food and cleaning, are horizontal. The support legs which are independently controllable in combination with the levelling arrangement enables this to be achieved. The camping unit has support legs that enable the camping unit to be supported and levelled on a support surface.

Additionally, the support legs also assist in both mounting the camping unit on a vehicle, and dismounting or removing the camping unit from the vehicle at the end of a trip. This substantially reduces the lifting effort and manual labour required to use the camping unit. For example, when the camping unit is mounted on a hitch of a vehicle, it can be supported on its legs and moved across the surface until it is adjacent the mounting position on the vehicle. The legs can then be adjusted so the unit is at the same height that it will be on the vehicle. The unit is then displaced into engagement with the hitch on the vehicle and the unit is then mounted on the vehicle. In particular, the unit does not need to be lifted off the ground and carried by persons from its storage position to the vehicle. Similarly, when the camping unit is dismounted from the vehicle in a reverse process to that described above, lifting and carrying the camping unit is substantially avoided.

Advantageously, typical size and weight characteristics together with wheeled legs allow the apparatus to be moved around manually, such as by pushing or pulling by a single person, when disconnected from a vehicle.

Advantageously, the presence of a base plate on legs of at least some embodiments of the apparatus provides support and stability and allows for levelling even on soft surfaces, such as sand.

A working advantage of the embodiment described above with reference to FIGS. 33 to 42 is that the jockey wheel can be manually adjusted to provide fine tolerance levelling in a front to rear direction transverse to the extendible legs. In combination with the controlled levelling in a lateral or transverse direction, the Applicant has devised a camping unit that can be suitably levelled for camping use and provides a high level of amenity.

It will be understood generally that the above description of embodiments of the invention is provided for purposes of description to one of ordinary skill in the related art. It is not intended to be exhaustive or to limit the invention to a single disclosed embodiment. In some instances, well-known components and/or processes have not been described in detail, so as not to obscure the embodiments described herein.

As described, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations that have been discussed herein, and other embodiments that fall within the spirit and scope of the invention.

What is claimed is:

1-51. (canceled)

52. A vehicle mounted camping unit comprising:
a unit housing for providing amenities for camping activities;
a vehicle mounting arrangement on which the unit housing is supported, the vehicle mounting arrangement being configured for operatively coupling the camping unit to a vehicle; and
a plurality of retractable support legs mounted on the unit housing that are extendible down to a support surface beneath the unit housing for supporting the camping unit on the support surface when it is detached from the vehicle, and wherein each support leg is able to be independently extended or shortened to adjust the height or inclination of the unit housing on the support surface, and each support leg has a wheel for running on the support surface.

53. The vehicle mounted camping unit according to claim 52, wherein each retractable support leg comprises two leg sections that are axially displaceable relative to each other, and a linear actuator for selectively driving displacement of the two leg sections relative to each other to extend or shorten the retractable support leg.

54. The vehicle mounted camping unit according to claim 52, further comprising a surface orienting arrangement for orienting a surface of the camping unit in a certain or desired orientation.

55. The vehicle mounted camping unit according to claim 54, wherein the surface orienting arrangement comprises a sensor for sensing an inclination of the surface and providing sensing information, and a controller that is operatively connected to the sensor for receiving the sensing information from the sensor, and the controller is operatively coupled to the retractable support legs to independently adjust the length of each retractable support leg in response to the sensing information and orient the surface.

56. The vehicle mounted camping unit according to claim 55, wherein the sensor is an accelerometer that is used to sense the inclination of the surface.

57. The vehicle mounted camping unit according to claim 52, wherein the vehicle mounting arrangement includes a hitch for coupling up to a hitch receiver on the camping vehicle, and a mounting displacement mechanism extending from the hitch for displacing the unit housing away from the hitch.

58. The vehicle mounted camping unit according to claim 57, wherein the mounting displacement mechanism displaces the unit housing between a travelling configuration in which the unit housing is proximate to the hitch, and an extended camping configuration in which the unit housing is spaced away from the hitch, and the mounting displacement mechanism comprises a slide mechanism including telescopic slide members that can slide axially relative to each other and support the unit housing.

59. The vehicle mounted camping unit according to claim 52, further including a shade structure mounted on the housing interchangeable between a stowed configuration in which it is retracted and a deployed configuration in which the shade structure extends over a support surface adjacent to the camping unit and provides shade.

60. The vehicle mounted camping unit according to claim 52, wherein the unit housing comprises inner and outer housing sections that are telescopically displaceable relative to each other between a compact travelling configuration and an expanded camping configuration, and wherein the outer housing section defines a covered internal space providing shelter in the expanded camping configuration.

61. A vehicle mounted camping unit, comprising:
a vehicle mounting arrangement for operatively mounting the camping unit onto a camping vehicle;
a unit housing mounted on the vehicle mounting arrangement, the unit housing forming a working counter surface, and a cook plate and/or a wash basin mounted on the unit housing in proximity to the working counter surface; and
a shade structure mounted on the unit housing and interchangeable between a stowed configuration in which it is retracted, and a deployed configuration in which it extends over a support surface area adjacent to the camping unit for providing shade.

62. The vehicle mounted camping unit according to claim 61, wherein the shade structure comprises a shade support that is pivotable up from the unit housing, a flexible shade sail extending from the shade support in use to provide shade, and two or more support posts mounted on the support surface and spaced from the unit housing in use to support the shade sail.

63. The vehicle mounted camping unit according to claim 61, wherein the unit housing comprises inner and outer housing sections that are telescopically displaceable relative to each other between a nested travelling configuration and an expanded camping configuration where the two sections are expanded relative to each other, and the outer section defines a covered internal space for use in camping activities.

64. The vehicle mounted camping unit according to claim 61, further comprising a plurality of retractable support legs on the unit housing, wherein each retractable support leg is independently adjustable whereby to enable the retractable support leg to be selectively extended or shortened to adjust the height of the unit housing.

65. The vehicle mounted camping unit according to claim 64, wherein each retractable support leg comprises two leg sections that are axially displaceable relative to each other, and a linear actuator for selectively driving displacement of the two leg sections relative to each other to extend or shorten the retractable support leg, and the camping unit further comprises a surface orienting arrangement for orienting a surface of the camping unit.

66. A vehicle mounted camping unit comprising:
a unit housing for providing amenities for camping activities;
a vehicle mounting arrangement on which the unit housing is supported, the vehicle mounting arrangement comprising a tow hitch that is configured for operatively coupling the camping unit to a vehicle; and
first and second retractable support legs mounted on the unit housing that are configured for supporting the unit housing on a support surface, the first and second retractable support legs being laterally spaced from each other on the unit housing and defining a transverse leg axis therebetween; and
a jockey wheel mounted on the vehicle mounting arrangement that is configured for supporting the vehicle mounting arrangement on the support surface,
wherein the first and second retractable support legs and the jockey wheel are operable to support the camping unit on the support surface when it is uncoupled from the vehicle.

67. The vehicle mounted camping unit according to claim 66, wherein each of the first and second retractable support legs can be independently extended or shortened to adjust a height of the unit housing, and each said retractable support leg has a wheel at a lower end thereof for running on the support surface.

68. The vehicle mounted camping unit according to claim 66, wherein the vehicle mounting arrangement defines an axial tow axis extending from the tow hitch to the unit housing, and the jockey wheel is positioned on or adjacent the tow axis, and the axial tow axis is substantially orthogonal to the transverse leg axis extending between the first and second retractable support legs.

69. The vehicle mounted camping unit according to claim 66, wherein the jockey wheel comprises a height adjusting arrangement, and the height adjusting arrangement is manually operable to adjust the height of the jockey wheel by means of a handle.

70. The vehicle mounted camping unit according to claim 66, further comprising a surface orienting arrangement for orienting a surface of the unit housing in a certain orientation along the transverse leg axis extending between the first and second retractable support legs.

71. The vehicle mounted camping unit according to claim 70, wherein the surface orienting arrangement comprises a sensor for sensing an inclination of the surface of the unit housing along the transverse leg axis, and a controller that is operatively connected to the sensor for receiving sensing information from the sensor, that is also operatively coupled to the first and second retractable support legs, wherein the controller independently adjusts the length of each of the first and second retractable support legs in response to the sensing information, to orient the surface of the unit housing.

72. The vehicle mounted camping unit according to claim 66, wherein the vehicle mounting arrangement further comprises a slide mechanism extending from the tow hitch, and the slide mechanism is able to displace the unit housing between a travelling configuration in which it is adjacent to the tow hitch, and an extended camping configuration in which the unit housing is spaced away from the tow hitch.

73. The vehicle mounted camping unit according to claim 66, wherein the tow hitch is configured to pivot on the hitch receiver in a substantially horizontal direction from one side to another side, and also to pivot on the hitch receiver in a substantially vertical direction up and down, thereby to enable the vehicle mounting arrangement to move in two dimensions relative to the hitch receiver to which it is operatively coupled.
